(19) United States
(12) Patent Application Publication
(10) Pub. No.: US 2025/0259778 A1
(43) Pub. Date: Aug. 14, 2025

(54) INDUCTOR COMPONENT

(71) Applicant: Murata Manufacturing Co., Ltd., Kyoto-fu (JP)

(72) Inventor: Eiji YAMAUCHI, Nagaokakyo-shi (JP)

(73) Assignee: Murata Manufacturing Co., Ltd., Kyoto-fu (JP)

(21) Appl. No.: 19/048,721

(22) Filed: Feb. 7, 2025

(30) Foreign Application Priority Data
Feb. 9, 2024 (JP) 2024-018694

(51) Int. Cl. H01F 27/28; H01F 27/255

(52) U.S. Cl. CPC H01F 27/2828; H01F 27/255

(57) ABSTRACT

An inductor component includes an element having a first main surface and including a magnetic layer, an inductor wire, and columnar wires. The inductor wire includes a pair of pad portions at two end portions of the inductor wire and to each of which a first end of a corresponding one of the columnar wires is connected, and includes a line-shaped wire body connecting the pair of pad portions. The wire body includes two or more parallel portions extending while being spaced one from another at regular intervals in a direction parallel to the first main surface. An axis orthogonal to the first main surface is defined as a first axis, and an axis orthogonal to the first axis and parallel to a direction in which the parallel portions are arranged is defined as a second axis.

### CROSS-REFERENCE TO RELATED APPLICATION

This application claims benefit of priority to Japanese Patent Application No. 2024-018694, filed Feb. 9, 2024, the entire content of which is incorporated herein by reference.

### BACKGROUND

### Technical Field

The present disclosure relates to an inductor component.

### Background Art

An inductor component disclosed in Japanese Unexamined Patent Application Publication No. 2022-38242 includes an element having a main surface, inductor wires, and a columnar wire. The element includes a magnetic layer. The inductor wires extend parallel to the main surface in the magnetic layer. The columnar wire extends in a direction intersecting with the main surface. The columnar wire extends from an end portion of the inductor wire to the main surface of the element.

### SUMMARY

In the inductor component described in Japanese Unexamined Patent Application Publication No. 2022-38242, a magnetic layer is disposed in each gap between the inductor wires adjacent to each other in a direction parallel to the main surface of the element. When the gap has an excessively large height relative to the width, filling the entirety of the gap with the magnetic layer is difficult. Thus, a space not filled with the magnetic layer may be left in the gap between the inductor wires.

Accordingly, the present disclosure provides an inductor component that includes an element having a main surface and including a magnetic layer, an inductor wire extending parallel to the main surface in the element, and columnar wires extending in the element in a direction intersecting with the main surface. The inductor wire includes a pair of pad portions located at two end portions of the inductor wire and to each of which a first end of a corresponding one of the columnar wires is connected, and includes a line-shaped wire body connecting the pair of pad portions. The wire body includes two or more parallel portions extending while being spaced one from another at regular intervals in a direction parallel to the main surface. Also, when an axis orthogonal to the main surface is defined as a first axis, and an axis orthogonal to the first axis and parallel to a direction in which the parallel portions are arranged is defined as a second axis, and when viewed in perspective in a direction parallel to the first axis, a first interval that is a shortest interval between each of the pad portions and the wire body in a direction parallel to the second axis is greater than a second interval that is a shortest interval between the parallel portions in the direction parallel to the second axis.

In addition, the present disclosure provides an inductor component that includes an element having a main surface and including a magnetic layer, a plurality of inductor wires extending parallel to the main surface in the element and arranged in a direction orthogonal to the main surface, and columnar wires extending in the element in a direction intersecting with the main surface. Each of the inductor wires includes a pair of pad portions located at two end portions of the inductor wire and to each of which a first end of a corresponding one of the columnar wires is connected, and includes a line-shaped wire body connecting the pair of pad portions. The wire body includes two or more parallel portions extending while being spaced one from another at regular intervals in a direction parallel to the main surface. Among the plurality of inductor wires, either one of the pad portions of the inductor wire farthest from the main surface in the direction orthogonal to the main surface is defined as a specific pad portion, and either one of the columnar wires extending from the specific pad portion toward the main surface is defined as a specific columnar wire. Also, when an axis orthogonal to the main surface is defined as a first axis, and an axis orthogonal to the first axis and parallel to a direction in which the parallel portions are arranged is defined as a second axis, two or more wire overlapping areas in each of which the parallel portions of the wire bodies overlap one another are included when viewed in perspective in a direction parallel to the first axis, and wherein, when viewed in perspective in the direction parallel to the first axis, a third interval that is a shortest interval between the specific pad portion and a corresponding one of the wire overlapping areas in a direction parallel to the second axis is greater than a fourth interval that is a shortest interval between the wire overlapping areas in the direction parallel to the second axis.

In the above structure, the interval between each of the columnar wires and the wire body adjacent to the columnar wire is sufficiently large to enhance the workability of filling a space between the columnar wire and the wire body with the magnetic layer.

### BRIEF DESCRIPTION OF THE DRAWINGS

FIG. 1 is a schematic perspective view of an inductor component according to a first embodiment;

FIG. 2 is a perspective plan view of the inductor component according to the first embodiment;

FIG. 3 is a cross-sectional view at a specific cross section of the inductor component taken along line 3-3 in FIG. 2;

FIG. 4 is a diagram illustrating a method for manufacturing the inductor component according to the first embodiment;

FIG. 5 is a diagram illustrating a method for manufacturing the inductor component according to the first embodiment;

FIG. 6 is a diagram illustrating a method for manufacturing the inductor component according to the first embodiment;

FIG. 7 is a diagram illustrating a method for manufacturing the inductor component according to the first embodiment;

FIG. 8 is a diagram illustrating a method for manufacturing the inductor component according to the first embodiment;

FIG. 9 is a diagram illustrating a method for manufacturing the inductor component according to the first embodiment;

FIG. 10 is a diagram illustrating a method for manufacturing the inductor component according to the first embodiment;

FIG. 11 is a diagram illustrating a method for manufacturing the inductor component according to the first embodiment;

FIG. 12 is a diagram illustrating a method for manufacturing the inductor component according to the first embodiment;

FIG. 13 is a diagram illustrating a method for manufacturing the inductor component according to the first embodiment;

FIG. 14 is a diagram illustrating a method for manufacturing the inductor component according to the first embodiment;

FIG. 15 is a diagram illustrating a method for manufacturing the inductor component according to the first embodiment;

FIG. 16 is a diagram illustrating a method for manufacturing the inductor component according to the first embodiment;

FIG. 17 is a diagram illustrating a method for manufacturing the inductor component according to the first embodiment;

FIG. 18 is a diagram illustrating a method for manufacturing the inductor component according to the first embodiment;

FIG. 19 is an exploded perspective view of an inductor component according to a second embodiment;

FIG. 20 is a perspective plan view of the inductor component according to the second embodiment; and

FIG. 21 is a cross-sectional view at a specific cross section of the inductor component taken along line 21-21 in FIG. 20.

### DETAILED DESCRIPTION

Inductor components according to a first embodiment and a second embodiment are described below with reference to the drawings. In the drawings, components may be enlarged for ease of understanding. The dimensional ratios of components may be different from the actual ones or different between different drawings.

### First Embodiment

### Entire Structure

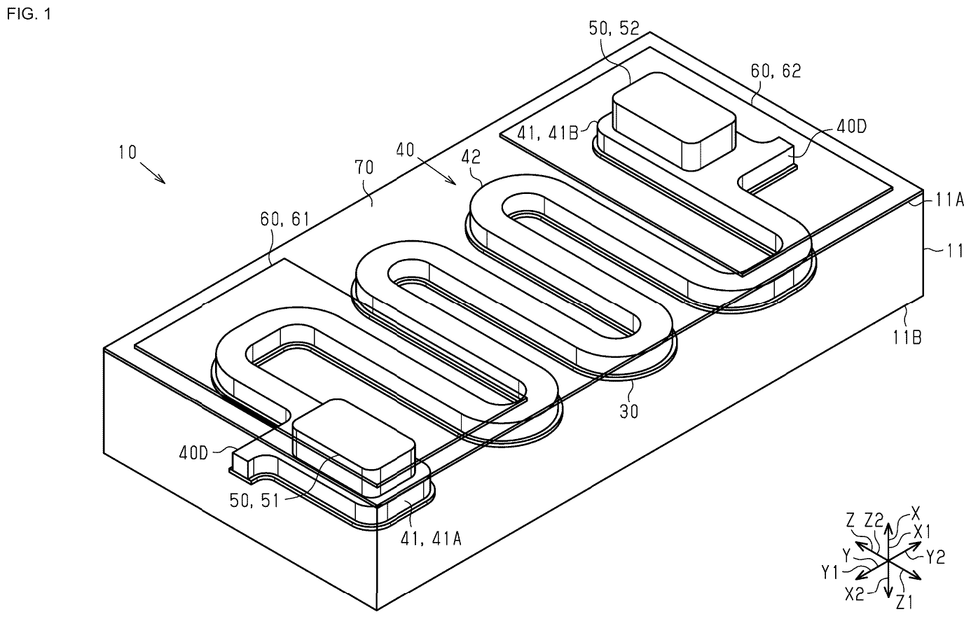

As illustrated in FIG. 1, the entirety of an inductor component 10 has a substantially rectangular prism shape. The inductor component 10 includes an element 11.

The element 11 has six flat outer surfaces. A specific one of these six outer surfaces is defined as a first main surface 11A. The surface opposite to the first main surface 11A and parallel to the first main surface 11A is defined as a second main surface 11B. The profile of the first main surface 11A and the profile of the second main surface 11B are rectangular. Being parallel includes, for example, parallelism within the allowable range of manufacturing tolerances. More specifically, being parallel indicates that a difference between a mean value of an interval between two members falls within a predetermined range. The predetermined range is, for example, less than or equal to 10%. In the present embodiment, the first main surface 11A is a mount surface that faces a substrate when the inductor component 10 is to be mounted on the substrate.

An axis orthogonal to the first main surface 11A is a first axis X. An axis orthogonal to the first axis X and parallel to a specific side of the first main surface 11A, in the present embodiment, a long side of the first main surface 11A is defined as a second axis Y. The second axis Y is an axis parallel to a direction in which parallel portions P, described later, are arranged. In addition, an axis orthogonal to the first axis X and the second axis Y is defined as a third axis Z. Of the direction parallel to the first axis X, a direction in which the first main surface 11A faces is defined as a first positive direction X1, and a direction opposite to the first positive direction X1 is defined as a first negative direction X2. In the present embodiment, the first positive direction X1 matches a direction from an inductor wire 40, described below, toward the first main surface 11A. Of the direction parallel to the second axis Y, a specific direction is defined as a second positive direction Y1, and a direction opposite to the second positive direction Y1 is defined as a second negative direction Y2. Of the direction parallel to the third axis Z, a specific direction is defined as a third positive direction Z1, and a direction opposite to the third positive direction Z1 is defined as a third negative direction Z2.

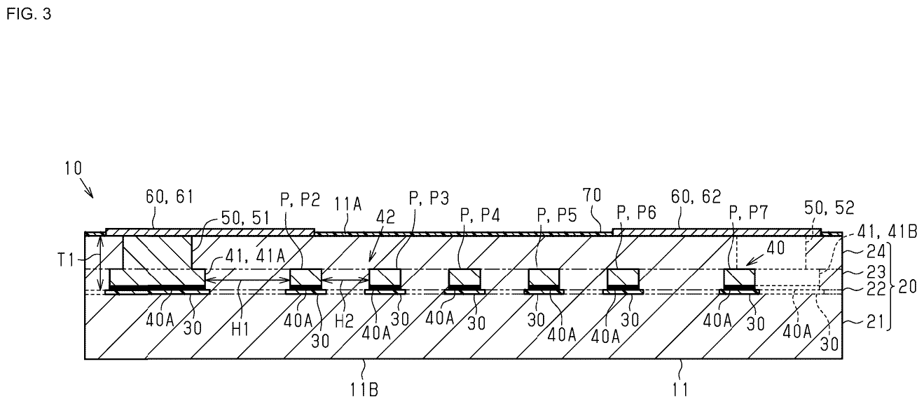

As illustrated in FIG. 3, the element 11 includes, as magnetic layers 20, a first magnetic layer 21, a second magnetic layer 22, a third magnetic layer 23, and a fourth magnetic layer 24. The first magnetic layer 21 to the fourth magnetic layer 24 are arranged in this order in the first positive direction X1. The surface of the first magnetic layer 21 facing in the first negative direction X2 serves as the second main surface 11B. The surface of the fourth magnetic layer 24 facing in the first positive direction X1 serves as the first main surface 11A. In FIG. 3, boundaries between the magnetic layers 20 are virtually illustrated with two-dot chain lines, but no clear boundaries may be observable between these magnetic layers 20. The material of these magnetic layers 20 is an organic resin containing magnetic metal powder. More specifically, the element 11 contains a magnetic material. In the present embodiment, the magnetic metal powder is formed from a Fe-based alloy or an amorphous alloy. More specifically, the magnetic metal powder is FeSiCr-based metal powder containing iron. Instead of the FeSiCr-based metal powder, the magnetic metal powder may be, for example, FeCo-based metal powder, FeSiAr-based metal powder, iron-oxide-based metal powder, or a mixture of two or more of these. The organic resin may be epoxy, an imide, a liquid-crystal polymer resin, an acrylic resin, a phenol resin, or a mixture of two or more of these. In addition to the above materials, an inorganic filler may be mixed in the organic resin.

Preferably, the minimum particle size of the magnetic powder is more than or equal to 1 μm. From such a dimensional relationship, an improvement of efficiency of obtaining an inductance value can be expected. A median particle size (D50) in particle size distribution of the magnetic powder is less than or equal to 10 μm. In the present embodiment, the median particle size (D50) in particle size distribution of the magnetic powder is approximately 8 μm.

For example, the median particle size (D50) of the magnetic powder is calculated in the manner below. First, magnetic powder is sampled by a scanning electron microscope (SEM) to obtain particle size distribution. In the particle size distribution, the frequency of particle sizes from the minimum particle size to the maximum particle size is calculated. The particle size at which the frequency reaches 50% is defined as the median particle size (D50).

The inductor component 10 includes an inductor wire 40. The inductor wire 40 is an electrically conductive member. The composition of the inductor wire 40 is, for example, more than or equal to 99 wt % of copper and more than or equal to 0.1 wt % and less than or equal to 1.0 wt % (i.e., from 0.1 wt % to 1.0 wt %) of sulfur. The material of the inductor wire 40 is not limited to a conductor mainly composed of cupper, and may be a conductor mainly composed of Ag, Al, or Au.

The inductor wire 40 is located in the element 11. The inductor wire 40 is located at the same position as the third magnetic layer 23 in a direction parallel to the first axis X.

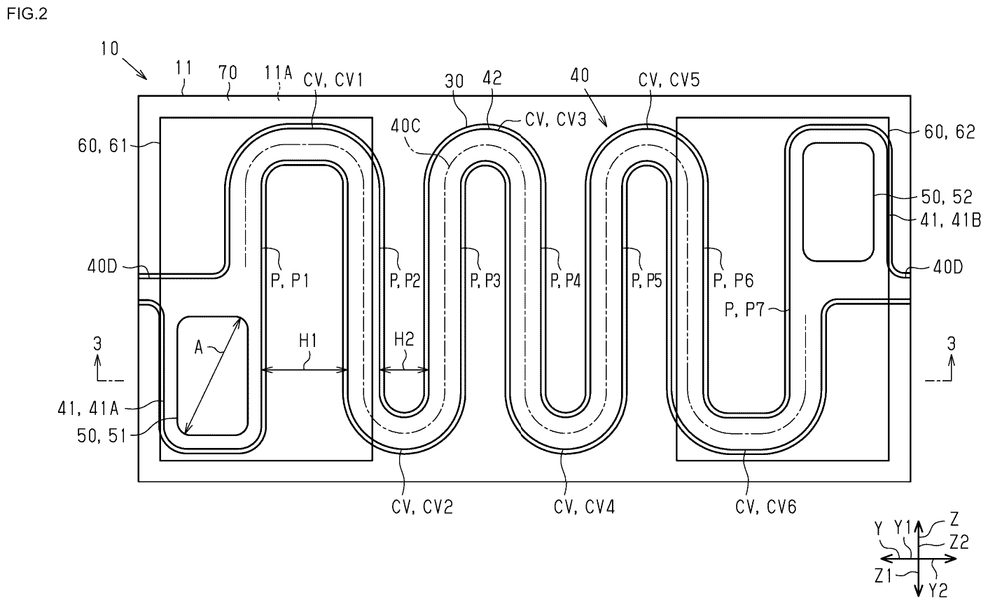

The inductor wire 40 includes a seed layer 40A. The seed layer 40A forms a surface of the inductor wire 40 facing in the first negative direction X2. The material of the seed layer 40A is copper. As described below, when electrolytic copper plating is performed on the seed layer 40A, copper grows on the seed layer 40A to form the entirety of the inductor wire 40. In the process of promoting the growth of copper plating, the surface of the inductor wire 40 facing in the first positive direction X1 may become a curved surface curving out in the first positive direction X1. FIG. 1 and FIG. 2 do not illustrate the seed layer 40A.

As illustrated in FIG. 2, the inductor wire 40 extends parallel to the first main surface 11A in the element 11. In the present embodiment, the inductor wire 40 extends in a meander form. More specifically, the inductor wire 40 extends while alternately turning rightward and leftward repeatedly. The inductor wire 40 includes a pair of pad portions 41 and a wire body 42. The pair of pad portions 41 are located at two end portions of the inductor wire 40. Hereinbelow, one of the pair of pad portions 41 is defined as a first end pad portion 41A. The remaining one of the pair of pad portions 41 is defined as a second end pad portion 41B.

When the element 11 is viewed in perspective in the first negative direction X2, the first end pad portion 41A is substantially rectangular. Two of the sides of the first end pad portion 41A are parallel to the second axis Y, and the remaining two sides are parallel to the third axis Z. The first end pad portion 41A is located in the second positive direction Y1 and the third positive direction Z1 with respect to the geometric center of the element 11.

When the element 11 is viewed in the first negative direction X2, the second end pad portion 41B is substantially rectangular. Two of the sides of the second end pad portion 41B are parallel to the second axis Y, and the remaining two sides are parallel to the third axis Z. The second end pad portion 41B is located in the second negative direction Y2 and the third negative direction Z2 with respect to the geometric center of the element 11. More specifically, the pair of pad portions 41 are spaced apart from each other in the direction parallel to the first main surface 11A, more specifically, in the direction parallel to the second axis Y.

The wire body 42 has a line shape. The wire body 42 connects the pair of pad portions 41. The dimension of the wire body 42 in the width direction orthogonal to a center line 40C is less than all the sides of the pad portion 41 when viewed in perspective in the first negative direction X2.

The center line 40C of the wire body 42 is defined as below. When viewed in perspective in the first negative direction X2, the shortest line segment among line segments drawable from any point on the edge of the wire body 42 to the opposite edge is specified. A line connecting points passing through the center of the specified line segment is defined as the center line 40C of the wire body 42 when viewed in perspective in the first negative direction X2.

The wire body 42 includes seven parallel portions P and six curve portions CV. The seven parallel portions P include a first parallel portion P1 to a seventh parallel portion P7. The six curve portions CV include a first curve portion CV1 to a sixth curve portion CV6. Each parallel portion P extends linearly along the third axis Z. As described above, the parallel portions P are arranged in a direction parallel to the second axis Y.

The first parallel portion P1 is connected to an edge of the first end pad portion 41A in the third negative direction Z2. The first parallel portion P1 to the seventh parallel portion P7 are arranged in this order in the second negative direction Y2. The seventh parallel portion P7 is connected to the edge of the second end pad portion 41B in the third positive direction Z1. The adjacent parallel portions P extend while being spaced from one another at regular intervals in a direction parallel to the first main surface 11A. More specifically, the adjacent parallel portions P extend parallel to one another. In the direction parallel to the second axis Y, the interval between the first parallel portion P1 and the second parallel portion P2 is the same as the interval between the sixth parallel portion P6 and the seventh parallel portion P7. In the direction parallel to the second axis Y, the intervals between adjacent two of the second parallel portion P2 to the sixth parallel portion P6 are the same.

The first curve portion CV1 connects an end of the first parallel portion P1 in the third negative direction Z2 and an end of the second parallel portion P2 in the third negative direction Z2. The first curve portion CV1 curves out in the third negative direction Z2. The second curve portion CV2 connects an end of the second parallel portion P2 in the third positive direction Z1 and an end of the third parallel portion P3 in the third positive direction Z1. The second curve portion CV2 curves out in the third positive direction Z1. The third curve portion CV3 connects an end of the third parallel portion P3 in the third negative direction Z2 and an end of the fourth parallel portion P4 in the third negative direction Z2. The third curve portion CV3 curves out in the third negative direction Z2. The fourth curve portion CV4 connects an end of the fourth parallel portion P4 in the third positive direction Z1 and an end of the fifth parallel portion P5 in the third positive direction Z1. The fourth curve portion CV4 curves out in the third positive direction Z1. The fifth curve portion CV5 connects an end of the fifth parallel portion P5 in the third negative direction Z2 and an end of the sixth parallel portion P6 in the third negative direction Z2. The fifth curve portion CV5 curves out in the third negative direction Z2. The sixth curve portion CV6 connects an end of the sixth parallel portion P6 in the third positive direction Z1 and an end of the seventh parallel portion P7 in the third positive direction Z1. The sixth curve portion CV6 curves out in the third positive direction Z1. Thus, when the element 11 is viewed in perspective in the first negative direction X2, the wire body 42 extends in a meander form from the first end pad portion 41A toward the second end pad portion 41B.

The inductor component 10 includes two dummy wires 40D. The dummy wires 40D are formed from the same material as the inductor wire 40. The dummy wires 40D are located at the same layer in the element 11 as the inductor wire 40. More specifically, the dummy wires 40D are located at the same position as the third magnetic layer 23 in the direction parallel to the first axis X.

One of the two dummy wires 40D extends in the second positive direction Y1 from the edge of the first end pad portion 41A in the second positive direction Y1. The end of this dummy wire 40D is exposed from the element 11. The other one of the two dummy wires 40D extends in the second negative direction Y2 from the edge of the second end pad portion 41B in the second negative direction Y2. The end of this dummy wire 40D is exposed from the element 11.

As illustrated in FIG. 3, the inductor component 10 includes an insulating layer 30. The insulating layer 30 is located in the first negative direction X2 with respect to the inductor wire 40 and the two dummy wires 40D. More specifically, the insulating layer 30 is located at the same position as the second magnetic layer 22 in the direction parallel to the first axis X. As illustrated in FIG. 2, the insulating layer 30 extends along the inductor wire 40 and the two dummy wires 40D. When viewed in perspective in the first negative direction X2, the profile of the insulating layer 30 is slightly larger than the profile of the inductor wire 40 and the profile of each dummy wire 40D.

As illustrated in FIG. 2, the inductor component 10 includes two columnar wires 50 and two outer electrodes 60. As illustrated in FIG. 3, each columnar wire 50 extends in a direction intersecting with the first main surface 11A. In the present embodiment, each columnar wire 50 extends in a direction orthogonal to the first main surface 11A. Each columnar wire 50 is located in the first positive direction X1 with respect to the inductor wire 40. More specifically, each columnar wire 50 is located at the same position as the fourth magnetic layer 24 in the direction parallel to the first axis X. Each columnar wire 50 is electrically connected with the inductor wire 40. Each columnar wire 50 is formed from the same material as the inductor wire 40.

The two columnar wires 50 include a first columnar wire 51 and a second columnar wire 52. The first columnar wire 51 is connected to the first end pad portion 41A. More specifically, the first end of the first columnar wire 51 is connected to the first end pad portion 41A. The first columnar wire 51 has a substantially quadrangular prism shape. As illustrated in FIG. 2, when viewed in perspective in the first negative direction X2, two of the sides of the first columnar wire 51 are parallel to the second axis Y, and the remaining two sides are parallel to the third axis Z. When viewed in perspective in the first negative direction X2, the profile of the first columnar wire 51 is smaller than the profile of the first end pad portion 41A.

As illustrated in FIG. 3, the first columnar wire 51 extends from the first end pad portion 41A toward the first main surface 11A. More specifically, the first columnar wire 51 extends from the inductor wire 40 toward the first main surface 11A in the element 11. The second end of the first columnar wire 51 is exposed from the first main surface 11A. The circumferential surface of the first columnar wire 51 is covered with the fourth magnetic layer 24 of the magnetic layer 20.

The second columnar wire 52 is connected to the second end pad portion 41B. More specifically, the first end of the second columnar wire 52 is connected to the second end pad portion 41B. The second columnar wire 52 has a substantially quadrangular prism shape. As illustrated in FIG. 2, when viewed in perspective in the first negative direction X2, two of the sides of the second columnar wire 52 are parallel to the second axis Y, and the remaining two sides are parallel to the third axis Z. When viewed in perspective in the first negative direction X2, the profile of the second columnar wire 52 is smaller than the profile of the second end pad portion 41B.

As illustrated in FIG. 3, the second columnar wire 52 extends from the second end pad portion 41B toward the first main surface 11A. More specifically, the second columnar wire 52 extends from the inductor wire 40 toward the first main surface 11A in the element 11. The second end of the second columnar wire 52 is exposed from the first main surface 11A. The circumferential surface of the second columnar wire 52 is covered with the fourth magnetic layer 24 of the magnetic layer 20.

As illustrated in FIG. 1, each outer electrode 60 is exposed from the element 11. More specifically, each outer electrode 60 is located on the first main surface 11A of the element 11. More specifically, each outer electrode 60 covers a part of the outer surfaces of the element 11. Although not illustrated, each outer electrode 60 has a three-layer structure including Cu, Ni, and Au in order in the first positive direction X1.

As illustrated in FIG. 2, the two outer electrodes 60 include a first outer electrode 61 and a second outer electrode 62. The first outer electrode 61 is located on the first main surface 11A, in the second positive direction Y1 with respect to the geometric center of the first main surface 11A. The first outer electrode 61 is connected to the second end of the first columnar wire 51 exposed from the first main surface 11A.

The second outer electrode 62 is located on the first main surface 11A, in the second negative direction Y2 with respect to the geometric center of the first main surface 11A. The second outer electrode 62 is located symmetrically to the first outer electrode 61 about the center line of the first main surface 11A in the direction parallel to the second axis Y. The second outer electrode 62 is connected to the second end of the second columnar wire 52 exposed from the first main surface 11A.

The inductor component 10 includes solder resist 70. The solder resist 70 covers a portion of the surface of the element 11 facing in the first positive direction X1, except the two outer electrodes 60. More specifically, the first main surface 11A of the element 11 is covered with the outer electrodes 60 and the solder resist 70 without being exposed. The solder resist 70 has higher insulating properties than the element 11.

### Dimensional Relationship in Each Wire

As illustrated in FIG. 2, the inductor component is viewed in perspective in the direction parallel to the first axis X. The shortest interval between each pad portion 41 and the wire body 42 in the direction parallel to the second axis Y is defined as a first interval H1. In the present embodiment, the first interval H1 is the shortest interval between the first end pad portion 41A and a corresponding one of the parallel portions P in the direction parallel to the second axis Y. When the inductor component is viewed in perspective in the direction parallel to the first axis X, the shortest interval between the parallel portions P in the direction parallel to the second axis Y is defined as a second interval H2. The first interval H1 is greater than the second interval H2. In FIG. 2 and FIG. 3, the first interval H1 and the second interval H2 are denoted with reference signs at some of the intervals.

As illustrated in FIG. 3, the inductor component 10 is viewed in cross section at a specific cross section orthogonal to the first main surface 11A and the center lines 40C of the parallel portions P, and including one or more pad portions 41 and two or more parallel portions P. In the present embodiment, a cross section of the inductor component 10 along the plane passing the center of the first end pad portion 41A and parallel to the first axis X and the second axis Y is defined as a specific cross section. The specific cross section of the present embodiment includes the first end pad portion 41A and a second parallel portion P2 to a seventh parallel portion P7. More specifically, in the present embodiment, the first interval H1 and the second interval H2 can be identified in the specific cross section. Thus, the dimensional relationship between wires in the specific cross section is described below.

When viewed in cross section at a specific cross section, the dimension of each of the parallel portions P in the direction parallel to the second axis Y, more specifically, the width is 64 μm. When viewed at the same specific cross section, the dimension of each of the parallel portions P in the direction parallel to the first axis X, more specifically, the thickness is 40 μm.

When viewed in cross section at the specific cross section, the dimension of the first end pad portion 41A in the direction parallel to the second axis Y is 200 μm. This dimension corresponds to the dimension of one side of the first end pad portion 41A when viewed in perspective in the first negative direction X2. When viewed at the same specific cross section, the dimension of the first end pad portion 41A in the direction parallel to the first axis X, more specifically, the thickness is 40 μm. The dimensions of the second end pad portion 41B are the same as the dimensions of the first end pad portion 41A.

When viewed in cross section at the specific cross section, the dimension of the first columnar wire 51 in the direction parallel to the second axis Y, that is, the width is 150 μm. This dimension corresponds to the dimension of one side of the first columnar wire 51 when viewed in perspective in the first negative direction X2. When viewed at the same specific cross section, the dimension of the first columnar wire 51 in the direction parallel to the first axis X, that is, the thickness is 65 μm. More specifically, when viewed at the same specific cross section, the ratio of the maximum dimension of the first columnar wire 51 in the direction orthogonal to the first main surface 11A, to the maximum dimension of the first columnar wire 51 in the direction parallel to the first main surface 11A is less than or equal to 2. More specifically, the ratio is approximately 0.43.

As illustrated in FIG. 2, when viewed in perspective in the direction parallel to the first axis X, the maximum dimension of the first columnar wire 51 in the direction parallel to the first main surface 11A is a dimension of a diagonal of the first columnar wire 51, or a dimension A of the diagonal. When viewed in perspective in the direction parallel to the first axis X, the dimension A of the diagonal of the first columnar wire 51 is 280 μm. When viewed in perspective in the direction parallel to the first axis X, the ratio of the maximum dimension of the first columnar wire 51 in the direction parallel to the first axis X, to the maximum dimension of the first columnar wire 51 in the direction parallel to the first main surface 11A is less than or equal to 2. More specifically, the ratio is approximately 0.23.

As illustrated in FIG. 3, when viewed in cross section at the specific cross section, the first interval H1 is the shortest interval between the first end pad portion 41A and the wire body 42 in the direction parallel to the second axis Y. More specifically, the first interval H1 is an interval between the first end pad portion 41A and the second parallel portion P2 at the specific cross section. The first interval H1 is 184 μm. When viewed in cross section at the specific cross section, the second interval H2 is the shortest interval between the parallel portions P in the direction parallel to the second axis Y. More specifically, the second interval H2 is an interval between adjacent two of the second parallel portion P2 to the sixth parallel portion P6 in the specific cross section. The second interval H2 is 103 μm. As described above, the first interval H1 is thus greater than the second interval H2.

As described above, the median particle size (D50) in particle size distribution of the magnetic powder is 8 μm. Thus, the median particle size (D50) in particle size distribution of the magnetic powder is less than or equal to one fifth of the first interval H1. More specifically, the median particle size (D50) in particle size distribution of the magnetic powder is less than or equal to one twentieth of the first interval H1.

The distance in the direction parallel to the first axis X from the surface of the first end pad portion 41A facing in the first negative direction X2 to the second end of the first columnar wire 51 in the first positive direction X1 is referred to as a post portion distance T1. The post portion distance T1 is 105 μm. More specifically, the post portion distance T1 is more than or equal to two times the maximum dimension of the parallel portions P in the direction parallel to the first axis X. More specifically, the post portion distance T1 is approximately 2.6 times the maximum dimension of the parallel portions P in the direction parallel to the first axis X.

The mean value of the distance in the direction parallel to the first axis X from the surface of the first end pad portion 41A in the first negative direction X2 to the second end of the first columnar wire 51 in the first positive direction X1 and the maximum dimension of the parallel portions P in the direction parallel to the first axis X is defined as a mean height. More specifically, the mean height is a mean value of the post portion distance T1 and the thickness of the parallel portions P. In the present embodiment, the mean height is 72.5 μm. The ratio of the mean height to the first interval H1 is defined as a first aspect ratio. The first aspect ratio is approximately 0.394.

The ratio of the maximum dimension of the parallel portions P in the direction parallel to the first axis X to the second interval H2 is defined as a second aspect ratio. The second aspect ratio is approximately 0.388. In the present embodiment, the ratio of the first aspect ratio to the second aspect ratio is approximately 1.015. More specifically, the ratio of the first aspect ratio to the second aspect ratio is greater than or equal to 0.9 and less than or equal to 1.1 (i.e., from 0.9 to 1.1). Thus, the second aspect ratio and the first aspect ratio are substantially equal considering, for example, the manufacturing tolerances.

### Method for Manufacturing Inductor Component

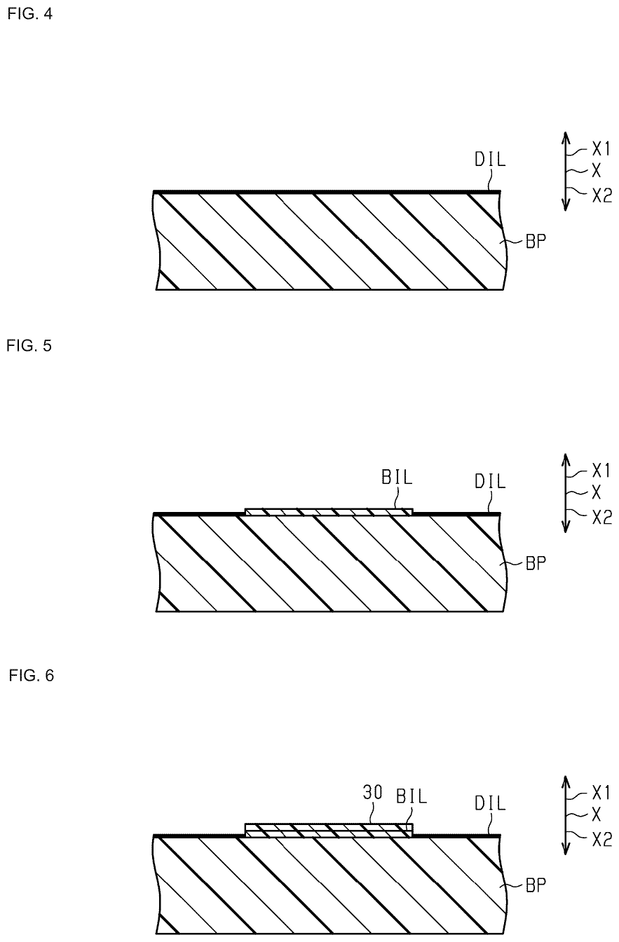

Subsequently, a method for manufacturing the inductor component 10 is described. FIG. 4 to FIG. 18 illustrating the manufacturing method typically illustrate a portion around the columnar wire 50.

As illustrated in FIG. 4, first, a base preparation process is performed. More specifically, a plate-shaped base member BP is prepared. The base member BP is formed from a ceramic material. In the description below, the main surface of the base member BP is orthogonal to the first axis X. When viewed in the first negative direction X2, the base member BP is, for example, quadrilateral. Each side of the base member BP has a dimension to receive multiple inductor components 10. A dummy insulating layer DIL is then applied to the entire surface of the base member BP facing in the first positive direction X1, that is, the entire upper surface. In FIG. 4, the dummy insulating layer DIL is drawn with a thick line.

As illustrated in FIG. 5, a process of processing a first insulating layer to form a base insulating layer BIL is performed. The base insulating layer BIL is formed on the surface of the base member BP facing in the first positive direction X1. More specifically, the base insulating layer BIL is patterned. Patterning is performed over an area slightly wider than the range over which the inductor wire 40 and the dummy wires 40D are disposed. More specifically, the base insulating layer BIL is formed by photolithography.

As illustrated in FIG. 6, a process of processing a second insulating layer to form the insulating layer 30 is performed. The insulating layer 30 is formed on the surface of the base insulating layer BIL facing in the first positive direction X1. The insulating layer 30 has the same shape as the base insulating layer BIL. The insulating layer 30 is formed in the same manner as the base insulating layer BIL.

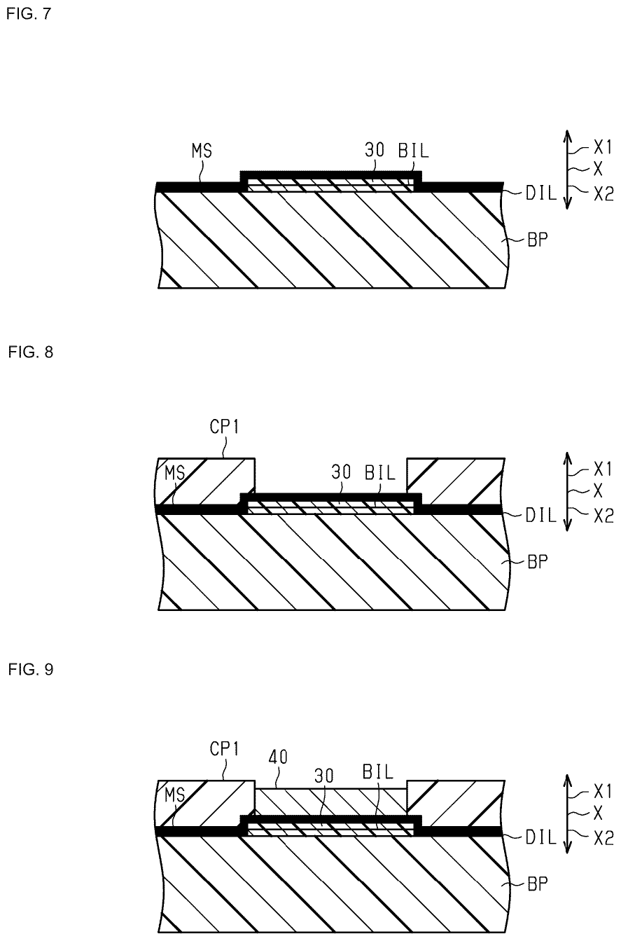

As illustrated in FIG. 7, a seed film forming process to form a seed film MS is then performed. More specifically, a copper seed film MS is formed by sputtering over the entire surfaces of the base member BP and the insulating layer 30 facing in the first positive direction X1.

As illustrated in FIG. 8, a first coating process to form a first coating portion CP1 is performed. More specifically, first, photosensitive dry film resist is applied to the entire surface of the seed film MS facing in the first positive direction X1. An area of the surface of the insulating layer 30 facing in the first positive direction X1 excluding a part is exposed to light to cure. The above area is a portion where the inductor wire 40 and the dummy wires 40D are not formed. Thereafter, the portion of the applied dry film resist left uncured is removed with a chemical solution. Thus, the cured portion of the applied dry film resist is formed into a first coating portion CP1. The seed film MS is exposed from the portion of the applied dry film resist removed by the chemical solution and left without being covered with the first coating portion CP1.

As illustrated in FIG. 9, an inductor wire processing process to form, by electrolytic plating, the inductor wire 40 and the dummy wires 40D at the portion of the surface of the insulating layer 30 facing in the first positive direction X1 left without being covered with the first coating portion CP1 is then performed. More specifically, by performing electrolytic copper plating, copper is grown from the portion where the seed film MS is exposed. Thus, the inductor wire 40 and the dummy wires 40D are formed. In FIG. 9, the dummy wires 40D are not illustrated.

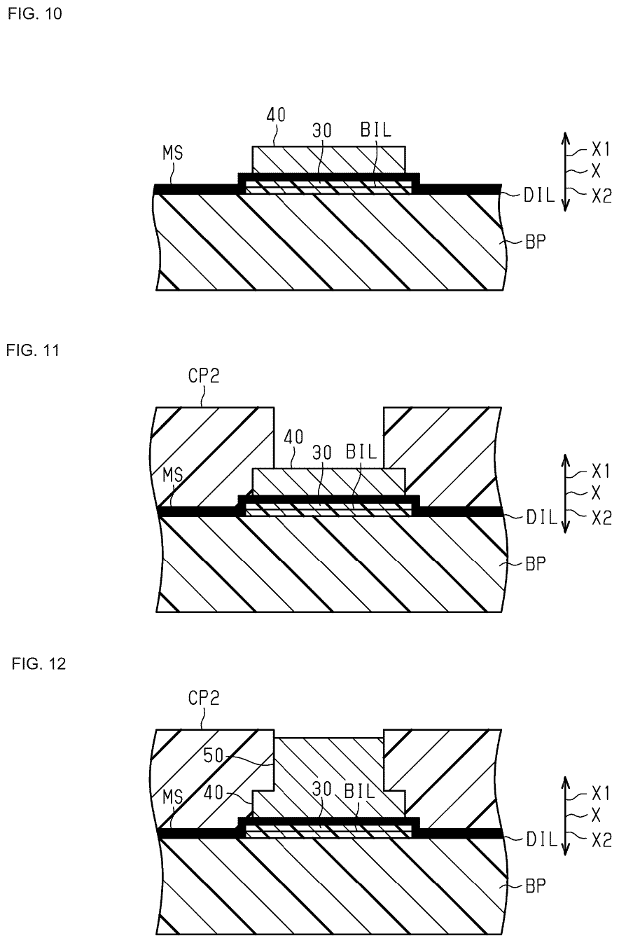

As illustrated in FIG. 10, a first coating portion removal process to remove the first coating portion CP1 is then performed. More specifically, the first coating portion CP1 is removed by a chemical solution.

As illustrated in FIG. 11, a second coating process to form a second coating portion CP2 is then performed. The range in which the second coating portion CP2 is formed is a range excluding a part of the inductor wire 40. More specifically, the above range is a portion in which the columnar wires 50 are not formed. The second coating portion CP2 is formed in this range by photolithography, the same as the method by which the first coating portion CP1 is formed.

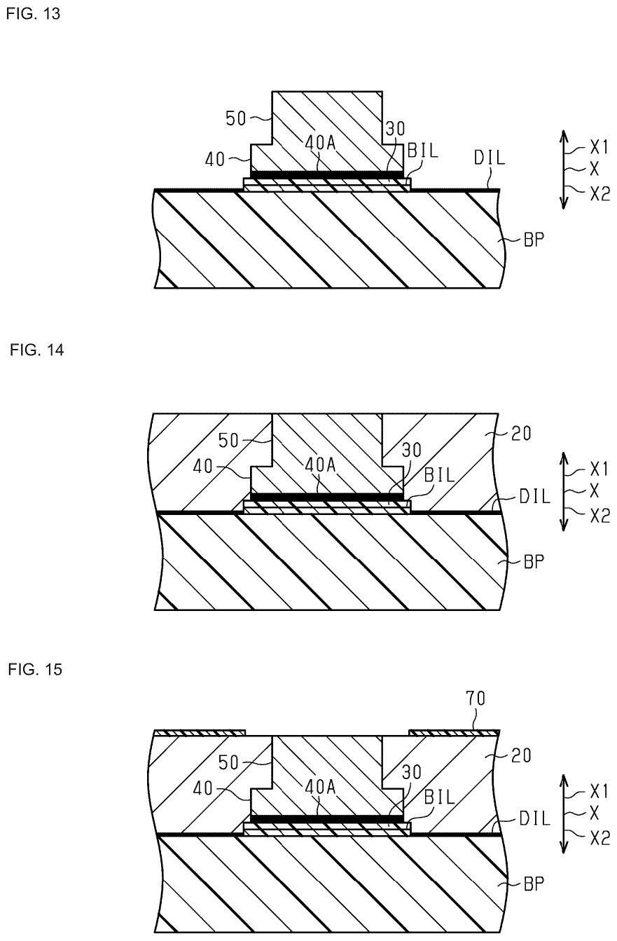

As illustrated in FIG. 12, a columnar wire processing process to form the columnar wires 50 is then performed. More specifically, of the surface of the inductor wire 40 facing in the first positive direction X1, each columnar wire 50 is formed at a portion not covered with the second coating portion CP2 by electrolytic copper plating, the same as the method by which the inductor wire 40 is formed. Thereafter, the end surface of each columnar wire 50 facing in the first positive direction X1 is abraded to allow the columnar wire 50 to have a desired dimension in the direction parallel to the first axis X.

As illustrated in FIG. 13, a second coating portion removal process to remove the second coating portion CP2 is then performed. In the second coating portion removal process, the second coating portion CP2 and the seed film MS at the portion in contact with the second coating portion CP2 are removed by wet etching. Thus, only the portion that is to serve as the seed layer 40A that forms a surface of the inductor wire 40 facing in the first negative direction X2 is left.

As illustrated in FIG. 14, a first lamination process to laminate the magnetic layers 20 other than the first magnetic layer 21 is then performed. First, resin containing magnetic powder serving as the material of the magnetic layers 20 is applied to the surfaces of the insulating layer 30 and the dummy insulating layer DIL facing the first positive direction X1. The resin containing the magnetic powder is then subjected to pressing to be cured to form the second magnetic layer 22, the third magnetic layer 23, and the fourth magnetic layer 24. At this time, the resin containing the magnetic powder is pressed to expose the surface of each columnar wire 50 facing in the first positive direction X1 and to be flush with the surface of the columnar wire 50 facing in the first positive direction X1. In FIG. 14, the second magnetic layer 22 to the fourth magnetic layer 24 are illustrated as the magnetic layer 20 without being distinguished from one another.

As illustrated in FIG. 15, a main surface processing process to form the solder resist 70 is performed. More specifically, an insulating member is patterned by photolithography on the end surface of the fourth magnetic layer 24 facing in the first positive direction X1 at a portion where each outer electrode 60 is not formed. Thus, the solder resist 70 is formed.

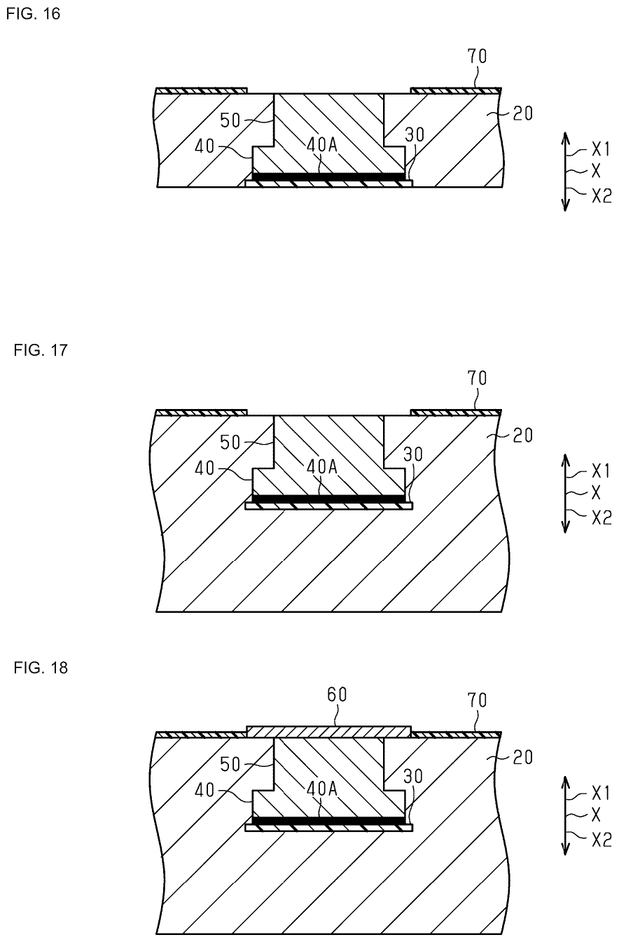

As illustrated in FIG. 16, a base member removal process is then performed. More specifically, first, an ultraviolet (UV) tape for protection is attached to the surface of the solder resist 70 facing in the first positive direction X1. Parts of the base member BP, the dummy insulating layer DIL, the base insulating layer BIL, and the magnetic layers 20 are removed by abrading. In the process of abrading the base insulating layer BIL, a part of the insulating layer 30 facing in the first negative direction X2 may be removed, but the inductor wire 40 is left unremoved. Thereafter, the UV tape attached to the solder resist 70 is removed.

As illustrated in FIG. 17, a second lamination process to laminate the first magnetic layer 21 is performed. More specifically, first, resin containing the magnetic powder serving as the material of the first magnetic layer 21 is applied to the surfaces of the second magnetic layer 22 and the insulating layer 30 facing in the first negative direction X2. The resin containing the magnetic powder is then pressed to cure. The UV tape for protection is attached to the surface of the solder resist 70 facing in the first positive direction X1. Thereafter, the portion of the cured resin facing in the first negative direction X2 is abraded. For example, a portion of the resin facing in the first negative direction X2 is abraded to allow the inductor component 10 to have a desired dimension in the direction parallel to the first axis X. The first magnetic layer 21 is thus formed on the surfaces of the second magnetic layer 22 and the insulating layer 30 facing in the first negative direction X2. The UV tape attached to the solder resist 70 is then removed. In FIG. 17, the first magnetic layer 21 to the fourth magnetic layer 24 are illustrated as the magnetic layer 20 without being distinguished from one another.

An electrode processing process to form the outer electrode 60 is then performed as illustrated in FIG. 18. The range over which the outer electrode 60 is formed is a range of the surface of the fourth magnetic layer 24 facing in the first positive direction X1 and the surface of each columnar wire 50 facing in the first positive direction X1, left without being covered with the solder resist 70. Electroless plating of copper, nickel, and gold is performed over this range. The first outer electrode 61 and the second outer electrode 62 are then formed. In FIG. 18, the copper, nickel, and gold layers are illustrated without being distinguished from one another. Although not illustrated, a part of the surface of the solder resist 70 facing in the first positive direction X1 may be covered with a part of the outer electrode 60. After the electrode processing process, the workpiece is cut with a dicing machine into the inductor components 10 with a desired size.

### Effects of First Embodiment

(1-1) In the above embodiment, the first interval H1 is greater than the second interval H2. More specifically, the interval between each one of the columnar wires 50 and the wire body 42 adjacent to the columnar wire 50 is sufficiently large. In this structure, a space between each one of the columnar wires 50 and the wire body 42 adjacent to the columnar wire 50 can be easily filled with the magnetic layers 20 regardless of when the space is around the columnar wire 50 having a relatively large dimension in the direction parallel to the first axis X. As described above, a space between each one of the columnar wires 50 and the wire body 42 adjacent to the columnar wire 50 can be easily filled with the magnetic layers 20. This structure can prevent an occurrence of a space left without being filled with the magnetic layers 20 between each columnar wires 50 and the wire body 42.

As an example embodiment to prevent an occurrence of a space between each columnar wires 50 and the wire body 42, in the first lamination process in the process of manufacturing the inductor component 10, an increase of the pressure exerted to fill the space with the magnetic layers 20 is conceivable. In the above structure, the pressure exerted to fill the space with the magnetic layers 20 does not have to be excessively increased. This structure can prevent a crack in the magnetic layers 20 caused by the pressure exerted to fill the space.

(1-2) In the above embodiment, the ratio of the first aspect ratio to the second aspect ratio is greater than or equal to 0.9 and less than or equal to 1.1 (i.e., from 0.9 to 1.1). In this manner, when the first aspect ratio and the second aspect ratio are substantially the same, the workability of filling the space with the magnetic layers 20 can be said as being consistent across the portions. When the workability of filling the space with the magnetic layers 20 is consistent, portions left without being filled with the magnetic layers 20 are not formed throughout the inductor component 10.

(1-3) As the ratio of the maximum dimension of the columnar wires 50 in the direction parallel to the first axis X to the maximum dimension of the columnar wires 50 in the direction parallel to the second axis Y when viewed in perspective in the first negative direction X2 is greater, the workability of filling the space around the columnar wires 50 with the magnetic layers 20 is lower. In the above embodiment, the ratio is less than or equal to 2. In this structure, the gaps between the columnar wires 50 and the parallel portions P can be filled with the magnetic layers 20 with high workability.

(1-4) In the above embodiment, the post portion distance T1 is more than or equal to two times the maximum dimension of the parallel portions P in the direction parallel to the first axis X. As above, also in the structure where the post portion distance T1 and the parallel portions P have a difference in height, the gaps between the columnar wires 50 and the parallel portions P are sufficiently large, and thus can be filled with the magnetic layers 20 with high workability.

(1-5) As the magnetic powder has a smaller particle size, the magnetic powder is more likely to be evenly arranged in the magnetic layers 20. In the above embodiment, in the particle size distribution of the magnetic powder, the median particle size (D50) is less than or equal to 10 μm. When having the median particle size (D50) of this size, the magnetic powder is more likely to be evenly arranged in the magnetic layers 20.

(1-6) In the above embodiment, in the particle size distribution of the magnetic powder, the median particle size (D50) is less than or equal to one fifth of the first interval H1. With such a dimensional relationship of the median particle size (D50), the magnetic powder is evenly arranged also in the gaps between each of the columnar wires 50 and a corresponding one of the parallel portions P.

### Second Embodiment

Hereinbelow, an inductor component according to a second embodiment is described. The same features as the first embodiment are not described or simply described.

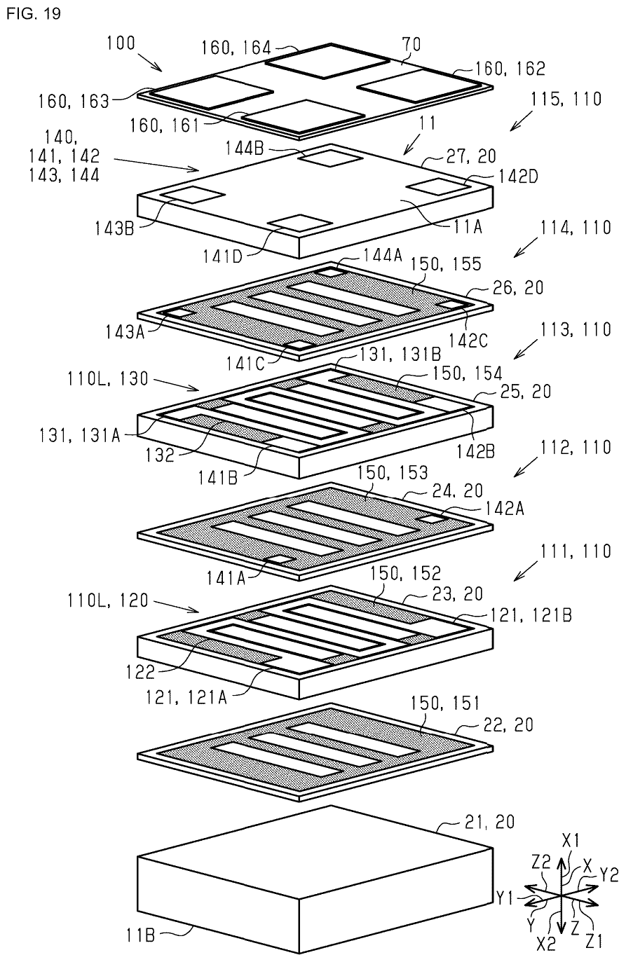

As illustrated in FIG. 19, the entirety of an inductor component 100 has a substantially rectangular prism shape. The inductor component 100 includes an element 11.

The element 11 has six flat outer surfaces. A specific one of these six outer surfaces is defined as a first main surface 11A. The surface opposite to the first main surface 11A and parallel to the first main surface 11A is defined as a second main surface 11B. The profile of the first main surface 11A and the profile of the second main surface 11B are rectangular. In the present embodiment, the first main surface 11A is a mount surface that faces a substrate when the inductor component 100 is to be mounted on the substrate.

In the same manner as in the case of the first embodiment, the first axis X, the second axis Y, and the third axis Z are defined. In the same manner as in the case of the first embodiment, the first positive direction X1, the first negative direction X2, the second positive direction Y1, the second negative direction Y2, the third positive direction Z1, and the third negative direction Z2 are defined. The first positive direction X1 matches a direction from inductor wires 110L, described below, toward the first main surface 11A. The second axis Y is parallel to a direction in which parallel portions Q of a first inductor wire 120 and parallel portions R of a second inductor wire 130 are arranged.

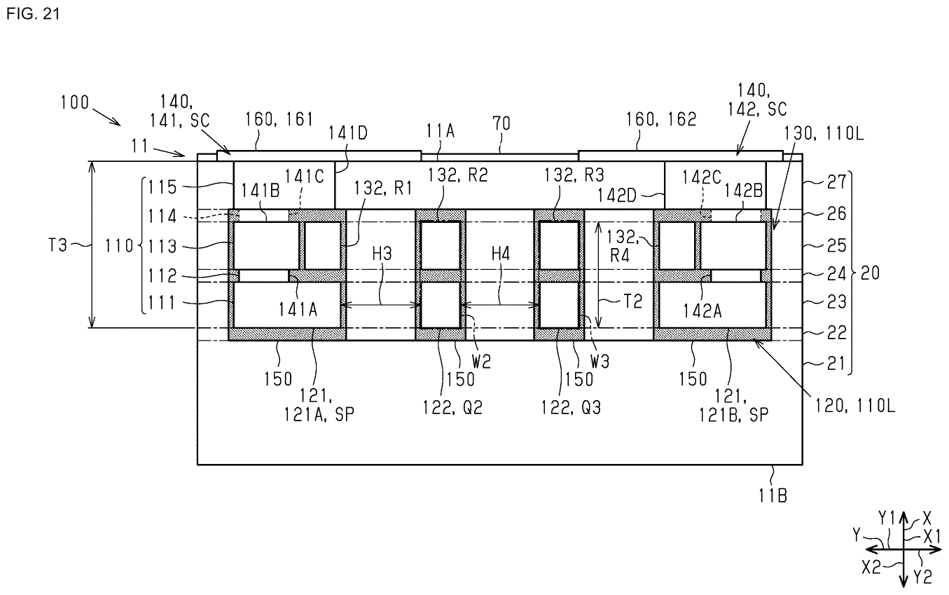

As illustrated in FIG. 21, the element 11 includes seven magnetic layers 20. The seven magnetic layers 20 include a first magnetic layer 21 to a seventh magnetic layer 27. The first magnetic layer 21 to the seventh magnetic layer 27 are arranged in this order in the first positive direction X1. The surface of the first magnetic layer 21 facing in the first negative direction X2 is the second main surface 11B. The surface of the seventh magnetic layer 27 facing in the first positive direction X1 is the first main surface 11A. In FIG. 21, boundaries between the magnetic layers 20 are virtually illustrated with two-dot chain lines, but no clear boundaries may be observable between these magnetic layers 20. The material of these magnetic layers 20 is the same as the material of the magnetic layers in the first embodiment. More specifically, the magnetic layers 20 contain magnetic powder.

### Inductor Wire

As illustrated in FIG. 19, the inductor component 100 includes, as the inductor wires 110L, the first inductor wire 120 and the second inductor wire 130. These two inductor wires 110L are arranged in the direction orthogonal to the first main surface 11A. The material of the inductor wires 110L is the same as the material of the inductor wires in the first embodiment. FIG. 19 does not illustrate a seed layer in the inductor wire 110L.

The first inductor wire 120 is located at the same position as the third magnetic layer 23 in the direction parallel to the first axis X. The first inductor wire 120 extends parallel to the first main surface 11A in the element 11. In the present embodiment, the first inductor wire 120 extends in a meander form. The first inductor wire 120 includes a pair of first pad portions 121 and a first wire body 122. The pair of first pad portions 121 are located at two end portions of the first inductor wire 120. One of the pair of first pad portions 121 is defined as a first end pad portion 121A. The remaining one of the pair of first pad portions 121 is defined as a second end pad portion 121B.

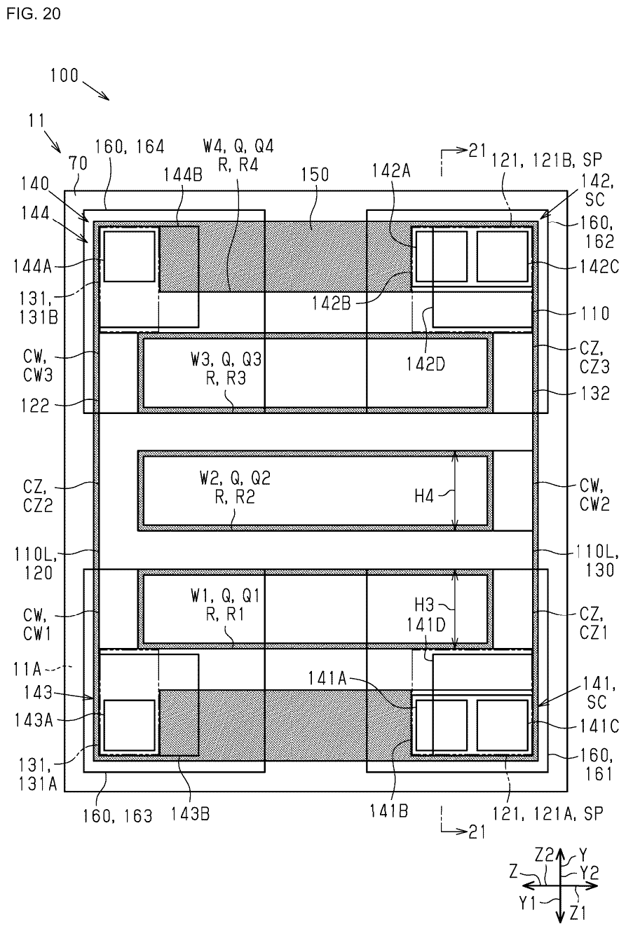

As illustrated in FIG. 20, the first end pad portion 121A of the first pad portion 121 is substantially rectangular when the element 11 is viewed in perspective in the first negative direction X2. In FIG. 20, a portion corresponding to the first end pad portion 121A is drawn with a two-dot chain line. Two of the sides of the first end pad portion 121A are parallel to the second axis Y, and the remaining two sides are parallel to the third axis Z. The first end pad portion 121A is located in the second positive direction Y1 and the third positive direction Z1 with respect to the geometric center of the element 11 when the element 11 is viewed in perspective in the first negative direction X2.

The second end pad portion 121B of the first pad portion 121 is substantially rectangular when the element 11 is viewed in perspective in the first negative direction X2. In FIG. 20, a portion corresponding to the second end pad portion 121B is drawn with a two-dot chain line. Two of the sides of the second end pad portion 121B are parallel to the second axis Y, and the remaining two sides are parallel to the third axis Z. The second end pad portion 121B is located in the second negative direction Y2 and the third positive direction Z1 with respect to the geometric center of the element 11 when viewed in perspective in the first negative direction X2.

As illustrated in FIG. 19, the first wire body 122 has a line shape. The first wire body 122 connects the pair of first pad portions 121. The dimension of the first wire body 122 in the width direction orthogonal to the center line is less than all the sides of the first pad portion 121 when viewed in perspective in the first negative direction X2. The center line of the first wire body 122 is defined in the same manner as the center line 40C of the wire body 42 according to the first embodiment.

As illustrated in FIG. 20, the first wire body 122 includes four parallel portions Q and three connection portions CW. The four parallel portions Q include a first parallel portion Q1, a second parallel portion Q2, a third parallel portion Q3, and a fourth parallel portion Q4. The parallel portions Q are arranged in the direction parallel to the second axis Y. Each of the parallel portions Q extends linearly along the third axis Z. As described above, the parallel portions Q extend while being spaced one from another at regular intervals in the direction parallel to the first main surface 11A. The three connection portions CW include a first connection portion CW1, a second connection portion CW2, and a third connection portion CW3. Each connection portion CW extends linearly in the direction parallel to the second axis Y.

The first parallel portion Q1 is connected to the end of the first end pad portion 121A in the third negative direction Z2. The first parallel portion Q1 to fourth parallel portion Q4 are arranged in this order in the second negative direction Y2. The fourth parallel portion Q4 is connected to the end of the second end pad portion 121B in the third negative direction Z2. In the direction parallel to the second axis Y, the interval between the first parallel portion Q1 and the second parallel portion Q2 is the same as the interval between the third parallel portion Q3 and the fourth parallel portion Q4. In the direction parallel to the second axis Y, the interval between the second parallel portion Q2 and the third parallel portion Q3 is shorter than the interval between the first parallel portion Q1 and the second parallel portion Q2.

The first connection portion CW1 connects the end of the first parallel portion Q1 in the third negative direction Z2 and the end of the second parallel portion Q2 in the third negative direction Z2. The second connection portion CW2 connects the end of the second parallel portion Q2 in the third positive direction Z1 and the end of the third parallel portion Q3 in the third positive direction Z1. The third connection portion CW3 connects the end of the third parallel portion Q3 in the third negative direction Z2 and the end of the fourth parallel portion Q4 in the third negative direction Z2.

As illustrated in FIG. 19, the second inductor wire 130 is located at the same position as a fifth magnetic layer 25 in the direction parallel to the first axis X.

As illustrated in FIG. 19, the second inductor wire 130 extends parallel to the first main surface 11A in the element 11. In the present embodiment, the second inductor wire 130 extends in a meander form. The second inductor wire 130 includes a pair of second pad portions 131 and a second wire body 132. The pair of second pad portions 131 are located at two end portions of the second inductor wire 130. One of the pair of second pad portions 131 is defined as a first end pad portion 131A. The remaining one of the pair of second pad portions 131 is defined as a second end pad portion 131B.

As illustrated in FIG. 20, the first end pad portion 131A of the second pad portion 131 is substantially rectangular when the element 11 is viewed in perspective in the first negative direction X2. In FIG. 20, a portion corresponding to the first end pad portion 131A is drawn with a two-dot chain line. Two of the sides of the first end pad portion 131A are parallel to the second axis Y, and the remaining two sides are parallel to the third axis Z. The first end pad portion 131A is located in the second positive direction Y1 and the third negative direction Z2 with respect to the geometric center of the element 11 when the element 11 is viewed in perspective in the first negative direction X2.

The second end pad portion 131B of the second pad portion 131 is substantially rectangular when the element 11 is viewed in perspective in the first negative direction X2. In FIG. 20, a portion corresponding to the second end pad portion 131B is drawn with a two-dot chain line. Two of the sides of the second end pad portion 131B are parallel to the second axis Y, and the remaining two sides are parallel to the third axis Z. The second end pad portion 131B is located in the second negative direction Y2 and the third negative direction Z2 with respect to the geometric center of the element 11 when viewed in perspective in the first negative direction X2.

As illustrated in FIG. 19, the second wire body 132 has a line shape. The second wire body 132 connects the pair of second pad portions 131. The dimension of the second wire body 132 in the width direction, orthogonal to the center line, is less than all the sides of the second pad portion 131 when viewed in perspective in the first negative direction X2. The center line of the second wire body 132 is defined similarly as in the case of the first wire body 122.

As illustrated in FIG. 20, the second wire body 132 includes four parallel portions R and three connection portions CZ. The four parallel portions R include a first parallel portion R1, a second parallel portion R2, a third parallel portion R3, and a fourth parallel portion R4. Each of the parallel portions R extends linearly along the third axis Z. The parallel portions R extend while being spaced one from another at regular intervals in the direction parallel to the first main surface 11A. The three connection portions CZ include a first connection portion CZ1, a second connection portion CZ2, and a third connection portion CZ3. Each connection portion CZ extends linearly along the second axis Y.

The first parallel portion R1 is connected to the edge of the first end pad portion 131A in the third positive direction Z1. The first parallel portion R1 to the fourth parallel portion R4 are arranged in this order in the second negative direction Y2. The fourth parallel portion R4 is connected to the edge of the second end pad portion 131B in the third positive direction Z1. In the direction parallel to the second axis Y, the interval between the first parallel portion R1 and the second parallel portion R2 is the same as the interval between the third parallel portion R3 and the fourth parallel portion R4. In the direction parallel to the second axis Y, the interval between the second parallel portion R2 and the third parallel portion R3 is shorter than the interval between the first parallel portion R1 and the second parallel portion R2.

The first connection portion CZ1 connects the end of the first parallel portion R1 in the third positive direction Z1 and the end of the second parallel portion R2 in the third positive direction Z1. The second connection portion CZ2 connects the end of the second parallel portion R2 in the third negative direction Z2 and the end of the third parallel portion R3 in the third negative direction Z2. The third connection portion CZ3 connects the end of the third parallel portion R3 in the third positive direction Z1 and the end of the fourth parallel portion R4 in the third positive direction Z1.

When viewed in perspective in the first negative direction X2, the first parallel portion R1 of the second wire body 132 overlaps the first parallel portion Q1 of the first wire body 122. When viewed in perspective in the first negative direction X2, the second parallel portion R2 of the second wire body 132 overlaps the second parallel portion Q2 of the first wire body 122. When viewed in perspective in the first negative direction X2, the third parallel portion R3 of the second wire body 132 overlaps the third parallel portion Q3 of the first wire body 122. When viewed in perspective in the first negative direction X2, the fourth parallel portion R4 of the second wire body 132 overlaps the fourth parallel portion Q4 of the first wire body 122.

### Columnar Wire

As illustrated in FIG. 19, the inductor component 100 includes four columnar wires 140. Each columnar wire 140 is electrically connected to the inductor wire 110L. The columnar wires 140 are formed from the same material as the inductor wire 110L.

The four columnar wires 140 include a first columnar wire 141, a second columnar wire 142, a third columnar wire 143, and a fourth columnar wire 144. Each columnar wire 140 extends in a direction intersecting with the first main surface 11A. In the present embodiment, each columnar wire 140 extends in a direction orthogonal to the first main surface 11A.

The first end of the first columnar wire 141 is connected to the first end pad portion 121A of the first inductor wire 120. The first columnar wire 141 extends from the first end pad portion 121A toward the first main surface 11A. The second end of the first columnar wire 141 is exposed from the first main surface 11A.

The first columnar wire 141 includes a first via 141A, a first extended portion 141B, a second via 141C, and a second extended portion 141D. The first via 141A of the first columnar wire 141 is located at the same position as the fourth magnetic layer 24 in the direction parallel to the first axis X. The first via 141A has a quadrangular prism shape. As illustrated in FIG. 20, when viewed in perspective in the first negative direction X2, the first via 141A overlaps a part of the first end pad portion 121A of the first pad portion 121. The dimension of the first via 141A in the direction parallel to the second axis Y is less than the dimension of the first end pad portion 121A of the first pad portion 121 in the direction parallel to the second axis Y. The dimension of the first via 141A in the direction parallel to the third axis Z is less than the dimension of the first end pad portion 121A of the first pad portion 121 in the direction parallel to the third axis Z. When viewed in perspective in the first negative direction X2, the entirety of the first via 141A overlaps the first end pad portion 121A. As illustrated in FIG. 21, the first end of the first via 141A in the first negative direction X2 is connected to the first end pad portion 121A of the first pad portion 121.

As illustrated in FIG. 19, the first extended portion 141B of the first columnar wire 141 is located at the same position as the fifth magnetic layer 25 in the direction parallel to the first axis X. The first extended portion 141B has a quadrangular prism shape. As illustrated in FIG. 20, when viewed in perspective in the first negative direction X2, the first extended portion 141B overlaps a part of the first end pad portion 121A of the first pad portion 121 and the first via 141A. The dimension of the first extended portion 141B in the direction parallel to the second axis Y is less than the dimension of the first end pad portion 121A of the first pad portion 121 in the direction parallel to the second axis Y. The dimension of the first extended portion 141B in the direction parallel to the third axis Z is substantially the same as the dimension of the first end pad portion 121A of the first pad portion 121 in the direction parallel to the third axis Z. When viewed in perspective in the first negative direction X2, the entirety of the first extended portion 141B overlaps the first end pad portion 121A. As illustrated in FIG. 21, the first end of the first extended portion 141B in the first negative direction X2 is connected to the first via 141A.

As illustrated in FIG. 19, the second via 141C of the first columnar wire 141 is located at the same position as a sixth magnetic layer 26 in the direction parallel to the first axis X. The second via 141C has a quadrangular prism shape. As illustrated in FIG. 20, when viewed in perspective in the first negative direction X2, the second via 141C overlaps a part of the first extended portion 141B of the first columnar wire 141 and a part of the first end pad portion 121A of the first pad portion 121. The second via 141C is located in the third positive direction Z1 with respect to the first via 141A. The dimension of the second via 141C in the direction parallel to the second axis Y is less than the dimension of the first end pad portion 121A of the first pad portion 121 in the direction parallel to the second axis Y. The dimension of the second via 141C in the direction parallel to the third axis Z is less than the dimension of the first end pad portion 121A of the first pad portion 121 in the direction parallel to the second axis Y. When viewed in perspective in the first negative direction X2, the entirety of the second via 141C overlaps the first end pad portion 121A and the first extended portion 141B. As illustrated in FIG. 21, the first end of the second via 141C in the first negative direction X2 is connected to the first extended portion 141B of the first columnar wire 141.

As illustrated in FIG. 19, the second extended portion 141D of the first columnar wire 141 is located at the same position as the seventh magnetic layer 27 in the direction parallel to the first axis X. The second extended portion 141D has a quadrangular prism shape. As illustrated in FIG. 20, when viewed in perspective in the first negative direction X2, the second extended portion 141D of the first columnar wire 141 overlaps a part of the first end pad portion 121A of the first pad portion 121, a part of the first via 141A of the first columnar wire 141, a part of the first extended portion 141B, and the second via 141C. The dimension of the second extended portion 141D in the direction parallel to the second axis Y is less than the dimension of the first end pad portion 121A of the first pad portion 121 in the direction parallel to the second axis Y. The dimension of the second extended portion 141D in the direction parallel to the third axis Z is less than the dimension of the first end pad portion 121A of the first pad portion 121 in the direction parallel to the third axis Z. More specifically, when viewed in perspective in the first negative direction X2, the entirety of the second extended portion 141D overlaps the first end pad portion 121A. As illustrated in FIG. 21, the first end of the second extended portion 141D in the first negative direction X2 is connected to the second via 141C. The surface of the second extended portion 141D facing in the first positive direction X1 is exposed from the first main surface 11A.

As illustrated in FIG. 19, the first end of the second columnar wire 142 is connected to the second end pad portion 121B of the first inductor wire 120. The second columnar wire 142 extends from the second end pad portion 121B toward the first main surface 11A. The second end of the second columnar wire 142 is exposed from the first main surface 11A.

The second columnar wire 142 includes a first via 142A, a first extended portion 142B, a second via 142C, and a second extended portion 142D.

The first via 142A of the second columnar wire 142 is located at the same position as the fourth magnetic layer 24 in the direction parallel to the first axis X. The first via 142A has a quadrangular prism shape. As illustrated in FIG. 20, when viewed in perspective in the first negative direction X2, the first via 142A overlaps a part of the second end pad portion 121B of the first pad portion 121. The dimension of the first via 142A in the direction parallel to the second axis Y is less than the dimension of the second end pad portion 121B of the first pad portion 121 in the direction parallel to the second axis Y. The dimension of the first via 142A in the direction parallel to the third axis Z is less than the dimension of the second end pad portion 121B of the first pad portion 121 in the direction parallel to the third axis Z. When viewed in perspective in the first negative direction X2, the entirety of the first via 142A overlaps the second end pad portion 121B. As illustrated in FIG. 21, the first end of the first via 142A in the first negative direction X2 is connected to the second end pad portion 121B of the first pad portion 121.

As illustrated in FIG. 19, the first extended portion 142B of the second columnar wire 142 is located at the same position as the fifth magnetic layer 25 in the direction parallel to the first axis X. The first extended portion 142B has a quadrangular prism shape. As illustrated in FIG. 20, when viewed in perspective in the first negative direction X2, the first extended portion 142B overlaps a part of the second end pad portion 121B of the first pad portion 121 and the first via 142A. The dimension of the first extended portion 142B in the direction parallel to the second axis Y is less than the dimension of the second end pad portion 121B of the first pad portion 121 in the direction parallel to the second axis Y. The dimension of the first extended portion 142B in the direction parallel to the third axis Z is substantially the same as the dimension of the second end pad portion 121B of the first pad portion 121 in the direction parallel to the third axis Z. When viewed in perspective in the first negative direction X2, the entirety of the first extended portion 142B overlaps the second end pad portion 121B. As illustrated in FIG. 21, the first end of the first extended portion 142B in the first negative direction X2 is connected to the first via 142A.

As illustrated in FIG. 19, the second via 142C of the second columnar wire 142 is located at the same position as the sixth magnetic layer 26 in the direction parallel to the first axis X. The second via 142C has a quadrangular prism shape. As illustrated in FIG. 20, when viewed in perspective in the first negative direction X2, the second via 142C overlaps a part of the first extended portion 142B of the second columnar wire 142 and a part of the second end pad portion 121B of the first pad portion 121. The second via 142C is located in the third positive direction Z1 with respect to the first via 142A. The dimension of the second via 142C in the direction parallel to the second axis Y is less than the dimension of the second end pad portion 121B of the first pad portion 121 in the direction parallel to the second axis Y. The dimension of the second via 142C in the direction parallel to the third axis Z is less than the dimension of the second end pad portion 121B of the first pad portion 121 in the direction parallel to the second axis Y. When viewed in perspective in the first negative direction X2, the entirety of the second via 142C overlaps the second end pad portion 121B and the first extended portion 142B. As illustrated in FIG. 21, the first end of the second via 142C in the first negative direction X2 is connected to the first extended portion 142B of the second columnar wire 142.

As illustrated in FIG. 19, the second extended portion 142D of the second columnar wire 142 is located at the same position as the seventh magnetic layer 27 in the direction parallel to the first axis X. The second extended portion 142D has a quadrangular prism shape. As illustrated in FIG. 20, when viewed in perspective in the first negative direction X2, the second extended portion 142D overlaps a part of the second end pad portion 121B of the first pad portion 121, a part of the first via 142A of the second columnar wire 142, a part of the first extended portion 142B, and the second via 142C. The dimension of the second extended portion 142D in the direction parallel to the second axis Y is less than the dimension of the second end pad portion 121B of the first pad portion 121 in the direction parallel to the second axis Y. The dimension of the second extended portion 142D in the direction parallel to the third axis Z is less than the dimension of the second end pad portion 121B of the first pad portion 121 in the direction parallel to the third axis Z. More specifically, when viewed in perspective in the first negative direction X2, the entirety of the second extended portion 142D overlaps the second end pad portion 121B. As illustrated in FIG. 21, the first end of the second extended portion 142D in the first negative direction X2 is connected to the second via 142C. The surface of the second extended portion 142D facing in the first positive direction X1 is exposed from the first main surface 11A.

As illustrated in FIG. 19, the first end of the third columnar wire 143 is connected to the first end pad portion 131A of the second inductor wire 130. The third columnar wire 143 extends from the first end pad portion 131A toward the first main surface 11A. The second end of the third columnar wire 143 is exposed from the first main surface 11A.

The third columnar wire 143 includes a first via 143A and a first extended portion 143B. The first via 143A of the third columnar wire 143 is located at the same position as the sixth magnetic layer 26 in the direction parallel to the first axis X. The first via 143A has a quadrangular prism shape. As illustrated in FIG. 20, when viewed in perspective in the first negative direction X2, the first via 143A overlaps a part of the first end pad portion 131A of the second pad portion 131. The dimension of the first via 143A in the direction parallel to the second axis Y is less than the dimension of the first end pad portion 131A of the second pad portion 131 in the direction parallel to the second axis Y. The dimension of the first via 143A in the direction parallel to the third axis Z is less than the dimension of the first end pad portion 131A of the second pad portion 131 in the direction parallel to the third axis Z. When viewed in perspective in the first negative direction X2, the entirety of the first via 143A overlaps the first end pad portion 131A. As illustrated in FIG. 19, the first end of the first via 143A in the first negative direction X2 is connected to the first end pad portion 131A of the second pad portion 131.

The first extended portion 143B of the third columnar wire 143 is located at the same position as the seventh magnetic layer 27 in the direction parallel to the first axis X. The first extended portion 143B has a quadrangular prism shape. As illustrated in FIG. 20, when viewed in perspective in the first negative direction X2, the first extended portion 143B overlaps a part of the first end pad portion 131A of the second pad portion 131, the first via 143A, and a part of an insulating layer 150 described later. The dimension of the first extended portion 143B in the direction parallel to the second axis Y is less than the dimension of the first end pad portion 131A of the second pad portion 131 in the direction parallel to the second axis Y. The dimension of the first extended portion 143B in the direction parallel to the third axis Z is greater than the dimension of the first end pad portion 131A of the second pad portion 131 in the direction parallel to the third axis Z. More specifically, when viewed in perspective in the first negative direction X2, the first extended portion 143B extends further beyond the first end pad portion 131A. A part of the extending portion of the first extended portion 143B overlaps the insulating layer 150. As illustrated in FIG. 19, the first end of the first extended portion 143B in the first negative direction X2 is connected to the first via 143A. The surface of the first extended portion 143B facing in the first positive direction X1 is exposed from the first main surface 11A.

The fourth columnar wire 144 is connected to the second end pad portion 131B of the second inductor wire 130. The fourth columnar wire 144 extends from the second end pad portion 131B toward the first main surface 11A. The second end of the fourth columnar wire 144 is exposed from the first main surface 11A.

The fourth columnar wire 144 includes a first via 144A and a first extended portion 144B. The first via 144A of the fourth columnar wire 144 is located at the same position as the sixth magnetic layer 26 in the direction parallel to the first axis X. The first via 144A has a quadrangular prism shape. As illustrated in FIG. 20, when viewed in perspective in the first negative direction X2, the first via 144A overlaps a part of the second end pad portion 131B of the second pad portion 131. The dimension of the first via 144A in the direction parallel to the second axis Y is less than the dimension of the second end pad portion 131B of the second pad portion 131 in the direction parallel to the second axis Y. The dimension of the first via 144A in the direction parallel to the third axis Z is less than the dimension of the second end pad portion 131B of the second pad portion 131 in the direction parallel to the third axis Z. When viewed in perspective in the first negative direction X2, the entirety of the first via 144A overlaps the second end pad portion 131B. As illustrated in FIG. 19, the first end of the first via 144A in the first negative direction X2 is connected to the second end pad portion 131B of the second pad portion 131.

The first extended portion 144B of the fourth columnar wire 144 is located at the same position as the seventh magnetic layer 27 in the direction parallel to the first axis X. The first extended portion 144B has a quadrangular prism shape. As illustrated in FIG. 20, when viewed in perspective in the first negative direction X2, the first extended portion 144B of the fourth columnar wire 144 overlaps a part of the second end pad portion 131B of the second pad portion 131, the first via 144A, and a part of the insulating layer 150, described later. The dimension of the first extended portion 144B in the direction parallel to the second axis Y is less than the dimension of the second end pad portion 131B of the second pad portion 131 in the direction parallel to the second axis Y. The dimension of the first extended portion 144B in the direction parallel to the third axis Z is greater than the dimension of the second end pad portion 131B of the second pad portion 131 in the direction parallel to the third axis Z. More specifically, when viewed in perspective in the first negative direction X2, the first extended portion 144B extends further beyond the second end pad portion 131B. A part of the extending portion of the first extended portion 144B overlaps the insulating layer 150. As illustrated in FIG. 19, the first end of the first extended portion 144B in the first negative direction X2 is connected to the first via 144A. The surface of the first extended portion 144B facing in the first positive direction X1 is exposed from the first main surface 11A.

### Insulating Layers and Outer Electrodes

As illustrated in FIG. 19, the inductor component 100 includes five insulating layers 150. The insulating layers 150 are located in the element 11. The five insulating layers 150 include a first insulating layer 151 to a fifth insulating layer 155. The first insulating layer 151 to the fifth insulating layer 155 are arranged in this order in the first positive direction X1.

A second insulating layer 152 is located at the same position as the third magnetic layer 23 and the first inductor wire 120 in the direction parallel to the first axis X. When viewed in perspective in the first negative direction X2, the profile of the second insulating layer 152 is substantially quadrilateral slightly smaller than the profile of the third magnetic layer 23. The profile of the second insulating layer 152 is slightly larger than an area surrounding the outermost edge of the first inductor wire 120 with straight lines. More specifically, when viewed in perspective in the first negative direction X2, the first inductor wire 120 is located inside the second insulating layer 152. The second insulating layer 152 is not located in three areas defined by the inductor wire 110L. More specifically, as illustrated in FIG. 19 and FIG. 20, when viewed in perspective in the first negative direction X2, the second insulating layer 152 is not located in a quadrilateral area slightly smaller than an area defined by the first parallel portion Q1, the second parallel portion Q2, the first connection portion CW1, and the first connection portion CZ1. When viewed in perspective in the first negative direction X2, the second insulating layer 152 is not located in a quadrilateral area slightly smaller than an area defined by the second parallel portion Q2, the third parallel portion Q3, the second connection portion CW2, and the second connection portion CZ2. When viewed in perspective in the first negative direction X2, the second insulating layer 152 is not located in a quadrilateral area slightly smaller than an area defined by the third parallel portion Q3, the fourth parallel portion Q4, the third connection portion CW3, and the third connection portion CZ3.

As illustrated in FIG. 19, the first insulating layer 151 is located at the same position as the second magnetic layer 22 in the direction parallel to the first axis X. When viewed in perspective in the first negative direction X2, the first insulating layer 151 has the same profile as the second insulating layer 152. As in the case of the second insulating layer 152, the first insulating layer 151 is not located in the above three areas defined by the inductor wire 110L.

A third insulating layer 153 is located at the same position as the fourth magnetic layer 24 in the direction parallel to the first axis X. When viewed in perspective in the first negative direction X2, the third insulating layer 153 has the same profile as the second insulating layer 152. As in the case of the second insulating layer 152, the third insulating layer 153 is located neither in the above three areas defined by the inductor wire 110L nor in an area where the first via 141A of the first columnar wire 141 and the first via 142A of the second columnar wire 142 are located.

A fourth insulating layer 154 is located at the same position as the fifth magnetic layer 25 in the direction parallel to the first axis X. When viewed in perspective in the first negative direction X2, the fourth insulating layer 154 has the same profile as the second insulating layer 152. As in the case of the second insulating layer 152, the fourth insulating layer 154 is located neither in the above three areas defined by the inductor wire 110L nor in an area where the first extended portion 141B of the first columnar wire 141, the first extended portion 142B of the second columnar wire 142, and the second inductor wire 130 are located.

The fifth insulating layer 155 is located at the same position as the sixth magnetic layer 26 in the direction parallel to the first axis X. When viewed in perspective in the first negative direction X2, the fifth insulating layer 155 has the same profile as the second insulating layer 152. As in the case of the second insulating layer 152, the fifth insulating layer 155 is located neither in the above three areas defined by the inductor wire 110L nor in an area where the second via 141C of the first columnar wire 141, the second via 142C of the second columnar wire 142, the first via 143A of the third columnar wire 143, and the first via 144A of the fourth columnar wire 144 are located.

As illustrated in FIG. 19, the inductor component 100 includes four outer electrodes 160. Each outer electrode 160 is located over the first main surface 11A. Each outer electrode 160 has the same lamination structure as the outer electrode in the first embodiment.

The four outer electrodes 160 include a first outer electrode 161, a second outer electrode 162, a third outer electrode 163, and a fourth outer electrode 164. The first outer electrode 161 is located on the first main surface 11A in the second positive direction Y1 and the third positive direction Z1 with respect to the geometric center of the first main surface 11A. The first outer electrode 161 is connected to an end surface of the first columnar wire 141 exposed from the first main surface 11A. More specifically, the first columnar wire 141 electrically connects the first end pad portion 121A of the first pad portion 121 of the first inductor wire 120 and the first outer electrode 161.

The second outer electrode 162 is located on the first main surface 11A in the second negative direction Y2 and the third positive direction Z1 with respect to the geometric center of the first main surface 11A. The second outer electrode 162 is connected to the end surface of the second columnar wire 142 exposed from the first main surface 11A. More specifically, the second columnar wire 142 electrically connects the second end pad portion 121B of the first pad portion 121 of the first inductor wire 120 and the second outer electrode 162.

The third outer electrode 163 is located on the first main surface 11A in the second positive direction Y1 and the third negative direction Z2 with respect to the geometric center of the first main surface 11A. The third outer electrode 163 is connected to the end surface of the third columnar wire 143 exposed from the first main surface 11A. More specifically, the third columnar wire 143 electrically connects the first end pad portion 131A of the second pad portion 131 of the second inductor wire 130 and the third outer electrode 163.

The fourth outer electrode 164 is located on the first main surface 11A in the second negative direction Y2 and the third negative direction Z2 with respect to the geometric center of the first main surface 11A. The fourth outer electrode 164 is connected to the end surface of the fourth columnar wire 144 exposed from the first main surface 11A. More specifically, the fourth columnar wire 144 electrically connects the second end pad portion 131B of the second pad portion 131 of the second inductor wire 130 and the fourth outer electrode 164.

The inductor component 10 includes solder resist 70. The solder resist 70 covers a portion of the first main surface 11A excluding the four outer electrodes 160. More specifically, the first main surface 11A of the element 11 are covered with the outer electrodes 160 and the solder resist 70 without being exposed. The solder resist 70 has higher insulating properties than the element 11.

### Wire Layer

As illustrated in FIG. 19, the inductor component 100 includes five wire layers 110 extending in the element 11 parallel to the first main surface 11A. The five wire layers 110 are defined as a first wire layer 111, a second wire layer 112, a third wire layer 113, a fourth wire layer 114, and a fifth wire layer 115 in order from the farthest from the first main surface 11A in the direction orthogonal to the first main surface 11A.

As illustrated in FIG. 19, the first wire layer 111 includes the first inductor wire 120. The second wire layer 112 includes the first via 141A of the first columnar wire 141 and the first via 142A of the second columnar wire 142. The third wire layer 113 includes the second inductor wire 130, the first extended portion 141B of the first columnar wire 141, and the first extended portion 142B of the second columnar wire 142. The fourth wire layer 114 includes the second via 141C of the first columnar wire 141, the second via 142C of the second columnar wire 142, the first via 143A of the third columnar wire 143, and the first via 144A of the fourth columnar wire 144. The fifth wire layer 115 includes the second extended portion 141D of the first columnar wire 141, the second extended portion 142D of the second columnar wire 142, the first extended portion 143B of the third columnar wire 143, and the first extended portion 144B of the fourth columnar wire 144.

### Dimensional Relationship Between Wires

As illustrated in FIG. 20 and FIG. 21, pad portions of one of the two inductor wires 110L farthest from the first main surface 11A in the direction orthogonal to the first main surface 11A are defined as specific pad portions SP. The columnar wires 140 connected to the specific pad portions SP are defined as specific columnar wires SC. In the second embodiment, the specific pad portions SP are the first pad portions 121. The specific columnar wires SC include the first columnar wire 141 and the second columnar wire 142. In the description below, the first end pad portion 121A of the first pad portion 121 is typically defined as the specific pad portion SP, and the first columnar wire 141 is typically defined as the specific columnar wire SC.

As illustrated in FIG. 20, the inductor component 100 includes wire overlapping areas where the parallel portions of the wire bodies overlap when viewed in perspective in the direction parallel to the first axis X. In the second embodiment, the inductor component 100 has four wire overlapping areas. The four wire overlapping areas include a first wire overlapping area W1 to a fourth wire overlapping area W4. The first wire overlapping area W1 is the smallest area including the first parallel portion Q1 of the first wire body 122, and the first parallel portion R1 of the second wire body 132. The second wire overlapping area W2 is the smallest area including the second parallel portion Q2 of the first wire body 122 and the second parallel portion R2 of the second wire body 132. The third wire overlapping area W3 is the smallest area including the third parallel portion Q3 of the first wire body 122 and the third parallel portion R3 of the second wire body 132. The fourth wire overlapping area W4 is the smallest area including the fourth parallel portion Q4 of the first wire body 122 and the fourth parallel portion R4 of the second wire body 132. In FIG. 21, the second wire overlapping area W2 and the third wire overlapping area W3 are drawn with two-dot chain lines.

As illustrated in FIG. 20, when viewed in perspective in the direction parallel to the first axis X, the shortest interval between the specific pad portion SP and the wire overlapping area in the direction parallel to the second axis Y is defined as a third interval H3. More specifically, the third interval H3 is an interval between the first end pad portion 121A and the second wire overlapping area W2 in the direction parallel to the second axis Y. In the present embodiment, the third interval H3 is 170 μm. In the present embodiment, the interval between the first end pad portion 121A and the second wire overlapping area W2 in the direction parallel to the second axis Y is the same as the interval between the second end pad portion 121B and the third wire overlapping area W3 in the direction parallel to the second axis Y.

When viewed in perspective in the direction parallel to the first axis X, the shortest interval between the wire overlapping areas in the direction parallel to the second axis Y is defined as a fourth interval H4. More specifically, the fourth interval H4 is an interval between the second wire overlapping area W2 and the third wire overlapping area W3 in the direction parallel to the second axis Y. The fourth interval H4 is 140 μm. The third interval H3 is thus greater than the fourth interval H4.

A specific cross section taken in a direction orthogonal to the first main surface 11A and the center line of each of the parallel portions, and taken to include one or more specific pad portions SP and two or more wire overlapping areas is viewed. The specific cross section in the present embodiment includes the specific pad portions SP, the second wire overlapping area W2, and the third wire overlapping area W3.

The distance, in the direction parallel to the first axis X, from the surface of each specific pad portion SP facing in the first negative direction X2 to the second end of a corresponding one of the specific columnar wires SC in the first positive direction X1 is defined as a five-layer distance T3. In the present embodiment, a distance from the first end pad portion 121A of the first pad portion 121 to the second extended portion 141D of the first columnar wire 141 is the same as a distance from the second end pad portion 121B of the first pad portion 121 to the second extended portion 142D of the second columnar wire 142. Thus, in the description below, a distance from surface of the first end pad portion 121A of the first pad portion 121 facing in the first negative direction X2 to the surface of the second extended portion 141D of the first columnar wire 141 facing in the first positive direction X1 is defined as a five-layer distance T3. The five-layer distance T3 is 450 μm.

The maximum dimension T2 of the wire overlapping area in the direction parallel to the first axis X is 300 μm. The mean value of the five-layer distance T3 and the maximum dimension T2 of the wire overlapping area in the direction parallel to the first axis X is defined as a mean distance. The mean distance is 375 μm.

The ratio of the mean distance to the third interval H3 is defined as a third aspect ratio. The third aspect ratio is approximately 2.21. The ratio of the maximum dimension T2 of the wire overlapping area in the direction parallel to the first axis X to the fourth interval H4 is defined as a fourth aspect ratio. The fourth aspect ratio is approximately 2.14. In the present embodiment, the ratio of the third aspect ratio to the fourth aspect ratio is approximately 1.03. More specifically, the ratio of the third aspect ratio to the fourth aspect ratio is greater than or equal to 0.9 and less than or equal to 1.1 (i.e., from 0.9 to 1.1).

### Effects of Second Embodiment

(2-1) In the above embodiment, the third interval H3 is greater than the fourth interval H4. More specifically, the interval between the specific pad portion SP and the second wire overlapping area W2 in the direction parallel to the second axis Y is sufficiently large. In other words, the interval between the specific pad portion SP connected to the first columnar wire 141 of the columnar wire 140 having a large dimension in the direction parallel to the first axis X and the parallel portion of each inductor wire 110L adjacent to the specific pad portion SP is sufficiently large. This structure is more likely to enhance the workability of filling a space between each specific pad portion SP and the corresponding wire overlapping area with the magnetic layers 20. The enhancement of the workability of filling a space between the specific pad portion SP and the wire overlapping area with the magnetic layers 20 prevents a space between each specific pad portion SP and the corresponding wire overlapping area from being left without being filled with the magnetic layers 20.

As an aspect of preventing an occurrence of a space between each specific pad portion SP and the corresponding wire overlapping area, an increase of the pressure exerted to fill the space with the magnetic layers 20 during the manufacturing process of the inductor component 100 is conceivable. The above structure has no need of excessively increasing the pressure exerted to fill the space with the magnetic layers 20. Thus, the above structure can reduce an occurrence of cracks in the magnetic layers 20 due to the pressure exerted during the filling.

(2-2) In the above embodiment, the ratio of the third aspect ratio to the fourth aspect ratio is greater than or equal to 0.9 and less than or equal to 1.1 (i.e., from 0.9 to 1.1). When the third aspect ratio and the fourth aspect ratio are equivalent as above, the workability of filling the space with the magnetic layers 20 can be said as being consistent across the portions. When the workability of filling the space with the magnetic layers 20 is consistent, portions left without being filled with the magnetic layers 20 are not formed throughout the inductor component 100.

### Modification Examples

The above embodiments may be implemented by being changed in the manner below. The first embodiment, the second embodiment, and modification examples described below may be implemented in combination within a range not technically contradictory.

In the first embodiment, the element 11 of the inductor component 10 may contain no magnetic powder. For example, the material of the element 11 may be, for example, a photosensitive resin material such as polyimide, ceramics, or glass. The same applies to the element 11 of the inductor component 100 according to the second embodiment.

In the first embodiment, each columnar wire 50 may extend in a direction intersecting with the first main surface 11A instead of the direction orthogonal to the first main surface 11A. The same applies to the columnar wire 140 according to the second embodiment.

In the first embodiment, each columnar wire 50 may have any shape other than the shape according to the above embodiments when viewed in perspective in the direction orthogonal to the first main surface 11A. For example, each columnar wire 50 may have a cylindrical shape. The same applies to the columnar wire 140 according to the second embodiment.

In the first embodiment, the inductor wire 40 may have any shape other than a meander form. The wire body 42 of the inductor wire 40 may have any shape having two or more parallel portions P extending parallel to one another between the pair of pad portions 41 in the direction parallel to the first main surface 11A. For example, the inductor wire 40 may be a spiral wire extending parallel to the first main surface 11A. The same applies to the wire body of each inductor wire 110L according to the second embodiment.

In the first embodiment, the inductor component 10 may include no outer electrode 60. In that case, a portion of each columnar wire 50 exposed from the first main surface 11A may be used as an electrode. The same applies to the inductor component 100 according to the second embodiment.

In the first embodiment, each outer electrode 60 may have a structure other than a structure obtained by laminating multiple layers. For example, in the above embodiment, each outer electrode 60 may be formed from a single metal layer. In addition, each outer electrode 60 may also have a layer formed from another material. The same applies to the outer electrode 160 according to the second embodiment.

In the first embodiment, the first interval H1 is not limited to the shortest interval between the first end pad portion 41A and the corresponding parallel portion P in a direction parallel to the second axis Y. In other words, the wire body 42 adjacent to the first end pad portion 41A in the direction parallel to the second axis Y may be other than the parallel portion P. More specifically, the first interval H1 may be any shortest interval between the first end pad portion 41A and the wire body 42 in the direction parallel to the second axis Y when viewed in perspective in the direction parallel to the first axis X.

In the first embodiment, the ratio of the first aspect ratio to the second aspect ratio may be less than 0.9. The ratio of the first aspect ratio to the second aspect ratio may be greater than 1.1.

In the first embodiment, the ratio of the maximum dimension of each columnar wire 50 in the direction parallel to the first axis X to the maximum dimension of each columnar wire 50 in the direction parallel to the first main surface 11A facing in the first negative direction X2 may be greater than 2.

In the first embodiment, the post portion distance T1 may be less than two times the maximum dimension of the parallel portions P in the direction orthogonal to the first main surface 11A.

In the first embodiment, the median particle size (D50) of the magnetic powder in particle size distribution may be greater than 10 μm. The median particle size (D50) in particle size distribution of the magnetic powder may be greater than one fifth of the first interval H1.

In the first embodiment, the smallest particle size of the magnetic powder is not limited to more than or equal to 1 μm.

In the second embodiment, a part of the inductor wire 110L may be left without being covered with the insulating layer 150 and may be in contact with any of the magnetic layers 20.

In the second embodiment, the ratio of the third aspect ratio to the fourth aspect ratio may be less than 0.9. The ratio of the third aspect ratio to the fourth aspect ratio may be greater than 1.1.

In the second embodiment, the number of wire overlapping areas is not limited to four. The inductor component 100 may have two or more wire overlapping areas.

In the second embodiment, in addition to the first inductor wire 120 and the second inductor wire 130, the inductor component 100 may include another inductor wire. In this case, the multiple inductor wires may be arranged in the direction parallel to the first axis X.

### APPENDIX

Technological ideas derived from the above embodiments and modification examples are described below.

[1] An inductor component, comprising an element having a main surface, and including a magnetic layer; an inductor wire extending parallel to the main surface in the element; and columnar wires extending in the element in a direction intersecting with the main surface. The inductor wire includes a pair of pad portions located at two end portions of the inductor wire and to each of which a first end of a corresponding one of the columnar wires is connected, and includes a line-shaped wire body connecting the pair of pad portions, wherein the wire body includes two or more parallel portions extending while being spaced one from another at regular intervals in a direction parallel to the main surface. An axis orthogonal to the main surface is defined as a first axis, and an axis orthogonal to the first axis and parallel to a direction in which the parallel portions are arranged is defined as a second axis. Also, when viewed in perspective in a direction parallel to the first axis, a first interval that is a shortest interval between each of the pad portions and the wire body in a direction parallel to the second axis is greater than a second interval that is a shortest interval between the parallel portions in the direction parallel to the second axis.

[2] The inductor component according to [1], wherein the columnar wires extend from the inductor wire toward the main surface. Also, of the direction parallel to the first axis, a direction from the inductor wire toward the main surface is defined as a positive direction, and a direction opposite to the positive direction is defined as a negative direction, wherein a mean value of a distance from a surface of each of the pad portions facing in the negative direction of the direction parallel to the first axis to a second end of a corresponding one of the columnar wires in the positive direction and a maximum dimension of the parallel portions in a direction orthogonal to the main surface is defined as a mean height, wherein a ratio of the mean height to the first interval is defined as a first aspect ratio, and wherein, when a ratio of the maximum dimension of the parallel portions in the direction parallel to the first axis to the second interval is defined as a second aspect ratio, a ratio of the first aspect ratio to the second aspect ratio is greater than or equal to 0.9 and less than or equal to 1.1 (i.e., from 0.9 to 1.1).

[3] The inductor component according to [1] or [2], wherein a ratio of a maximum dimension of the columnar wires in the direction parallel to the first axis to a maximum dimension of the columnar wires in the direction parallel to the main surface when viewed in perspective in the direction parallel to the first axis is less than or equal to 2.

[4] The inductor component according to any one of [1] to [3], wherein, when, of the direction parallel to the first axis, a direction from the inductor wire toward the main surface is defined as a positive direction, and a direction opposite to the positive direction is defined as a negative direction, a distance from a surface of each of the pad portions facing in the negative direction of the direction parallel to the first axis to a second end of a corresponding one of the columnar wires in the positive direction is more than or equal to two times a maximum dimension of the parallel portions in the direction parallel to the first axis.

[5] The inductor component according to any one of [1] to [4], wherein the magnetic layer includes magnetic powder, and wherein a median particle size (D50) in particle size distribution of the magnetic powder is less than or equal to 10 μm.

[6] The inductor component according to any one of [1] to [5], wherein the magnetic layer includes magnetic powder, and wherein a median particle size (D50) in particle size distribution of the magnetic powder is less than or equal to one fifth of the first interval.

[7] An inductor component, comprising an element having a main surface and including a magnetic layer; a plurality of inductor wires extending parallel to the main surface in the element and arranged in a direction orthogonal to the main surface; and columnar wires extending in the element in a direction intersecting with the main surface. Each of the inductor wires includes a pair of pad portions located at two end portions of the inductor wire and to each of which a first end of a corresponding one of the columnar wires is connected, and includes a line-shaped wire body connecting the pair of pad portions, wherein the wire body includes two or more parallel portions extending while being spaced one from another at regular intervals in a direction parallel to the main surface. Either one of the pad portions of one of the plurality of inductor wires farthest from the main surface in the direction orthogonal to the main surface is defined as a specific pad portion, and a corresponding one of the columnar wires extending from the specific pad portion toward the main surface is defined as a specific columnar wire. When an axis orthogonal to the main surface is defined as a first axis, and an axis orthogonal to the first axis and parallel to a direction in which the parallel portions are arranged is defined as a second axis, two or more wire overlapping areas in each of which the parallel portions of the wire bodies overlap one another are included when viewed in perspective in a direction parallel to the first axis. Also, when viewed in perspective in the direction parallel to the first axis, a third interval that is a shortest interval between the specific pad portion and a corresponding one of the wire overlapping areas in a direction parallel to the second axis is greater than a fourth interval that is a shortest interval between the wire overlapping areas in the direction parallel to the second axis.

[8] The inductor component according to [7], wherein, of the direction parallel to the first axis, a direction from each of the inductor wire toward the main surface is defined as a positive direction, and a direction opposite to the positive direction is defined as a negative direction. A mean value of a distance from a surface of the specific pad portion facing in the negative direction of the direction parallel to the first axis to a second end of the specific columnar wire in the positive direction and a maximum dimension of each of the wire overlapping areas in the direction parallel to the first axis is defined as a mean distance. A ratio of the mean distance to the third interval is defined as a third aspect ratio. Also, when a ratio of the maximum dimension of the wire overlapping area in the direction parallel to the first axis to the fourth interval is defined as a fourth aspect ratio, a ratio of the third aspect ratio to the fourth aspect ratio is greater than or equal to 0.9 and less than or equal to 1.1 (i.e., from 0.9 to 1.1).

What is claimed is:

1. An inductor component, comprising:
an element having a main surface, and including a magnetic layer;
an inductor wire extending parallel to the main surface in the element; and
columnar wires extending in the element in a direction intersecting with the main surface,
wherein
the inductor wire includes a pair of pad portions at two end portions of the inductor wire and each of the pair of the pad portions being connected to a first end of a corresponding one of the columnar wires, and includes a line-shaped wire body connecting the pair of pad portions,
the wire body includes two or more parallel portions extending while being spaced one from another at regular intervals in a direction parallel to the main surface,
an axis orthogonal to the main surface is defined as a first axis, and an axis orthogonal to the first axis and parallel to a direction in which the parallel portions are arranged is defined as a second axis, and
when viewed in perspective in a direction parallel to the first axis, a first interval that is a shortest interval between each of the pad portions and the wire body in a direction parallel to the second axis is greater than a second interval that is a shortest interval between the parallel portions in the direction parallel to the second axis.

2. The inductor component according to claim 1, wherein
the columnar wires extend from the inductor wire toward the main surface,
of the direction parallel to the first axis, a direction from the inductor wire toward the main surface is defined as a positive direction, and a direction opposite to the positive direction is defined as a negative direction,
a mean value of a distance from a surface of each of the pad portions facing in the negative direction of the direction parallel to the first axis to a second end of a corresponding one of the columnar wires in the positive direction and a maximum dimension of the parallel portions in a direction orthogonal to the main surface is defined as a mean height,
a ratio of the mean height to the first interval is defined as a first aspect ratio, and
when a ratio of the maximum dimension of the parallel portions in the direction parallel to the first axis to the second interval is defined as a second aspect ratio, a ratio of the first aspect ratio to the second aspect ratio is from 0.9 to 1.1.

3. The inductor component according to claim 1, wherein
a ratio of a maximum dimension of the columnar wires in the direction parallel to the first axis to a maximum dimension of the columnar wires in the direction parallel to the main surface when viewed in perspective in the direction parallel to the first axis is less than or equal to 2.

4. The inductor component according to claim 1, wherein
when, of the direction parallel to the first axis, a direction from the inductor wire toward the main surface is defined as a positive direction, and a direction opposite to the positive direction is defined as a negative direction, a distance from a surface of each of the pad portions facing in the negative direction of the direction parallel to the first axis to a second end of a corresponding one of the columnar wires in the positive direction is more than or equal to two times a maximum dimension of the parallel portions in the direction parallel to the first axis.

5. The inductor component according to claim 1, wherein
the magnetic layer includes magnetic powder, and
a median particle size (D50) in particle size distribution of the magnetic powder is less than or equal to 10 μm.

6. The inductor component according to claim 1, wherein
the magnetic layer includes magnetic powder, and
a median particle size (D50) in particle size distribution of the magnetic powder is less than or equal to one fifth of the first interval.

7. An inductor component, comprising:
an element having a main surface and including a magnetic layer;
a plurality of inductor wires extending parallel to the main surface in the element and arranged in a direction orthogonal to the main surface; and
columnar wires extending in the element in a direction intersecting with the main surface,
wherein
each of the inductor wires includes a pair of pad portions at two end portions of the inductor wire and to each of which a first end of a corresponding one of the columnar wires is connected, and includes a line-shaped wire body connecting the pair of pad portions,
the wire body includes two or more parallel portions extending while being spaced one from another at regular intervals in a direction parallel to the main surface,
either one of the pad portions of one of the plurality of inductor wires farthest from the main surface in the direction orthogonal to the main surface is defined as a specific pad portion, and a corresponding one of the columnar wires extending from the specific pad portion toward the main surface is defined as a specific columnar wire,
when an axis orthogonal to the main surface is defined as a first axis, and an axis orthogonal to the first axis and parallel to a direction in which the parallel portions are arranged is defined as a second axis, two or more wire overlapping areas in each of which the parallel portions of the wire bodies overlap one another are included when viewed in perspective in a direction parallel to the first axis, and
when viewed in perspective in the direction parallel to the first axis, a third interval that is a shortest interval between the specific pad portion and a corresponding one of the wire overlapping areas in a direction parallel to the second axis is greater than a fourth interval that is a shortest interval between the wire overlapping areas in the direction parallel to the second axis.

8. The inductor component according to claim 7, wherein
of the direction parallel to the first axis, a direction from each of the inductor wire toward the main surface is defined as a positive direction, and a direction opposite to the positive direction is defined as a negative direction,
a mean value of a distance from a surface of the specific pad portion facing in the negative direction of the direction parallel to the first axis to a second end of the specific columnar wire in the positive direction and a maximum dimension of each of the wire overlapping areas in the direction parallel to the first axis is defined as a mean distance,
a ratio of the mean distance to the third interval is defined as a third aspect ratio, and
when a ratio of the maximum dimension of the wire overlapping area in the direction parallel to the first axis to the fourth interval is defined as a fourth aspect ratio, a ratio of the third aspect ratio to the fourth aspect ratio is from 0.9 to 1.1.
